(19) United States
(12) Patent Application Publication
(10) Pub. No.: US 2012/0015858 A1
(43) Pub. Date: Jan. 19, 2012

(54) CLEANING AGENT

(75) Inventors: Arnd Kessler, Monheim and Rhein (DE); Christian Nitsch, Dusseldorf (DE); Thorsten Bastigkeit, Wuppertal (DE); Johannes Zipfel, Dusseldorf (DE); Erik Brückner, Hilden (DE)

(73) Assignee: Henkel AG & Co. KGaA, Dusseldorf (DE)

(21) Appl. No.: 13/245,059

(22) Filed: Sep. 26, 2011

Related U.S. Application Data
(63) Continuation of application No. PCT/EP2010/054306, filed on Mar. 31, 2010.

(30) Foreign Application Priority Data
Apr. 1, 2009 (DE) 10 2009 002 094.2

(51) Int. Cl. C11D 17/00

(52) U.S. Cl. 510/221; 510/406; 510/293

(57) ABSTRACT

The invention relates to a packed form of a washing or cleaning agent comprising (a) a first liquid washing or cleaning agent preparation A comprising (i) builder and (ii) complexing agent; (b) a second liquid washing or cleaning agent preparation B, of different composition than preparation A, comprising (i) greater than 1 wt. % water; (ii) at least 5 wt. % of at least one active washing or cleaning enzyme preparation; (iii) less than 10 wt. % phosphate; and (iv) less than 2.5 wt. % complexing agent; and (c) a packaging means, in which the washing or cleaning agent preparations A and B are contained and physically separate from one another, and wherein the inventive packaged form of a washing or cleaning agent is characterized by good storage stability and temperature stability, and good washing and cleaning performance.

### CROSS-REFERENCE TO RELATED APPLICATIONS

This application is a continuation of PCT Application Serial No. PCT/EP2010/054306, filed on Mar. 31, 2010, which claims priority under 35 U.S.C. §119 to 10 2009 002 094.2 (DE), filed on Apr. 1, 2009. The disclosures PCT/EP2010/054306 and DE 10 2009 002 094.2 are hereby incorporated by reference in their entirety.

### FIELD OF THE INVENTION

The present invention generally relates to washing and cleaning agents, and more particularly relates to washing and cleaning agents that contain enzymes.

### BACKGROUND OF THE INVENTION

The manufactured forms and packaged/marketed forms of washing and cleaning agents are constantly subject to new modifications. In this regard, a main focus for some time has been on the convenient metering of washing and cleaning agents and the simplification of the process stages required for carrying out a washing or cleaning process.

In this context, devices for the repeated dosing of washing and cleaning agents have recently become a focus of attention for the product developer. These devices may include metering containers integrated into the automatic dishwasher or washing machine, or devices that are independent from the automatic dishwasher or washing machine. In the course of a plurality of sequential cleaning stages, portions of washing or cleaning agent are automatically or semi-automatically metered into the interior of the cleaning machine by these devices that contain the multiple doses of cleaning agent required for carrying out a cleaning process. The consumer therefore no longer needs to dose the cleaning agent prior to each individual cleaning cycle. Examples of such devices are described in the European patent application EP 1 759 624 A2 (Reckitt Benckiser) and in the German patent application DE 10 2005 062 479 A1 (BSH Bosch and Siemens Hausgeräte, GmbH).

Independently of the exact design of the dosing devices placed in the interior of the automatic dishwashers or washing machines, the washing or cleaning agents that are contained in these devices for multiple dosing are exposed for a long period of time to fluctuating temperatures approximately equivalent to the temperatures of the water used for carrying out the washing or cleaning process. These temperatures can be up to 95° C., wherein in automatic dishwashing usually temperatures between 50 and 75° C. are attained. In the course of multiple washing or cleaning processes a washing or cleaning agent contained in a device intended for multiple dosing will therefore be repeatedly heated to temperatures significantly above those that are usual for transportation and storage; temperature-sensitive, active substances will be particularly affected. The group of these temperature-sensitive active washing and cleaning substances includes primarily the active washing and cleaning enzymes.

The use of enzymes to improve the washing and cleaning power of washing and cleaning agents has been established in the prior art for some decades. Due to their direct cleaning action hydrolytic enzymes such as proteases, amylases or lipases are often a component of cleaning agents used on fabrics or table ware.

Proteases, especially serine proteases, serve to degrade protein-containing stains on the product being cleaned. Subtilases, due to their favorable enzymatic properties, such as stability or pH where activity is optimized, have a preeminent position among the washing and cleaning proteases.

From the amylase enzyme class, the α-amylases are prevalent; α-amylases (E.C. 3.2.1.1) hydrolyze internal α-1,4-glycosidic bonds of starch and starch-like polymers.

In washing and cleaning agents incorporating enzymes, the cleaning action is not only determined by enzyme structure, but also to a significant degree by the type of packaging of the enzyme and its stabilization against environmental influences.

Active washing and cleaning enzymes may comprise both in solid as well as liquid forms. The group of solid enzyme preparations includes in particular the enzyme granulates consisting of a plurality of ingredients, and which are preferably incorporated into solid washing and cleaning agents. On the other hand, liquid or gel type washing and cleaning agents frequently comprise liquid enzyme preparations, these being much less protected against external influences than the enzyme granulates.

A series of different protective measures have been proposed in order to increase the stability of these types of enzyme-containing liquid washing or cleaning agents. For example, the German patent application DE 2 038 103 (Henkel) teaches stabilization of enzyme-containing dishwashing agents by use of saccharides, whereas propylene glycol is disclosed in the European patent EP 646 170 B1 (Procter & Gamble) for stabilizing enzymes in liquid cleaning agents.

The hitherto found methods described in the prior art for stabilizing enzymes take into account only to a limited extent the problematic nature of repeated exposure to high temperatures, as for example that will occur in the above described devices for multiple dosing of washing or cleaning agents. The previously known methods of stabilization are only suitable to a limited extent to avoid a loss of activity or to avoid segregation of the enzyme in liquid cleaning agents.

Accordingly, the object of the present application is the stabilization of an active washing or cleaning enzyme preparation against phase separation and loss of activity during multiple variations in temperature, in particular within a temperature range of 10 to 75° C. Suitable enzyme preparations should be storable without significant loss of activity in a storage device located in the interior of the automatic dishwasher or washing machine.

Furthermore, other desirable features and characteristics of the present invention will become apparent from the subsequent detailed description of the invention and the appended claims, taken in conjunction with the background of the invention.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

It has now been surprisingly found that the storage and temperature stability as well as the washing and cleaning power of a washing or cleaning agent composition can be improved by physically separating the enzyme-containing formulation into at least two separate formulations, in so far as ingredients such as the builders and the complexing agents can be selectively distributed among the separate formulations.

Accordingly, an embodiment of the present invention is a packaged washing or cleaning agent comprising: (a) a first liquid washing or cleaning agent preparation (“A”) comprising builder and complexing agent; (b) a second liquid washing or cleaning agent preparation (“B”) comprising: greater than 1 wt. % water; at least 5 wt. % of at least one active washing or cleaning enzyme preparation; less than 10 wt. % phosphate; and, less than 2.5 wt. % complexing agent; and (c) a packaging means that contains both the first and second washing or cleaning agent preparations, keeping them physically separated; and wherein the first and second liquid washing or cleaning agent preparations have different compositions. The designation of “liquid” physical form for these first and second washing or cleaning agent preparations refers to the physical form these preparations have at 20° C. The first preparation may also be designated as “preparation A” and the second preparation may also be designated as “preparation B” herein for simplicity. The “packaged form” is the equivalent of the “presentation form” of the inventive washing or cleaning agent throughout.

The subject matter of this application is washing and cleaning agent presentation forms that are obtained by combining two liquid washing or cleaning agent preparations A and B. The liquid washing and cleaning agent preparations A and B differ from one another in regard to their composition.

In a preferred embodiment, the washing or cleaning agent presentation form additionally contains a liquid washing or cleaning agent preparation C, wherein the washing or cleaning agent preparation C preferably differs from the washing or cleaning agent preparations A and B.

The washing or cleaning agent preparation A comprises one or more builders as the first essential ingredient. In particular, the builders include carbonates, phosphates, organic co-builders and silicates.

The washing or cleaning agent presentation forms according to the invention are preferably those wherein the builder is selected from the group of the carbonates, the hydrogen carbonates, the citrates, the phosphates, the silicates, the polymeric carboxylates and the polymeric sulfonates.

Preferred washing or cleaning agent presentation forms include a washing or cleaning agent presentation A that, based on its total weight, comprises 2 to 50 wt. %, preferably 6 to 45 wt. % and in particular 10 to 40 wt. % builder.

The builders for use in washing or cleaning agent preparation A are preferably selected from the group of the carbonates and/or hydrogen carbonates, preferably alkali metal carbonate(s), particularly preferably sodium carbonate, in quantities of 2 to 30 wt. %, preferably 3 to 20 wt. % and especially 4 to 15 wt. %, each based on the weight of the washing or cleaning preparation.

In particular, polycarboxylates/polycarboxylic acids, polymeric carboxylates, aspartic acid, polyacetals, dextrins and other organic co builders may be cited as the organic co builders. These classes of substances are described below.

Useful organic builders are, for example, the polycarboxylic acids that can be used in the form of the free acid and/or their sodium salts, polycarboxylic acids in this context being understood to be carboxylic acids that carry more than one acid function. These include, for example, citric acid, adipic acid, succinic acid, glutaric acid, malic acid, tartaric acid, maleic acid, fumaric acid, sugar acids, amino carboxylic acids, nitrilotriacetic acid (NTA), providing such use is not ecologically unsafe, and mixtures thereof. Besides their building effect, the free acids also typically have the property of an acidifying component and hence also serve to establish a relatively low and mild pH of washing or cleaning agents. Citric acid, succinic acid, glutaric acid, adipic acid, gluconic acid and any mixtures thereof are particularly mentioned in this regard.

Particularly preferred inventive washing or cleaning agent preparations A comprise citrate as one of the essential builders. Washing or cleaning agent presentation forms, wherein the washing or cleaning agent presentation A, based on its total weight, comprises 2 to 40 wt. %, preferably 5 to 30 wt. %, and in particular 7 to 20 wt. % citrate, are inventively preferred. Citrate or citric acid, especially combined with phosphonate, in particular 1-hydroxyethane-1,1-diphosphonic acid, and/or the sulfonic acid group-containing copolymers, have proven to be the most effective builders in regard to the cleaning power such as the rinsing power and in particular the inhibition of deposits.

Other suitable builders are polymeric polycarboxylates, for example the alkali metal salts of polyacrylic or polymethacrylic acid, for example those with a relative molecular weight of 500 to 70 000 g/mol.

Particularly suitable polymers are polyacrylates, which preferably have a molecular weight of 2 000 to 20 000 g/mol. By virtue of their superior solubility, preferred representatives of this group are again the short-chain polyacrylates, which have molecular weights of 2 000 to 10 000 g/mol and, more particularly, 3 000 to 5 000 g/mol.

Further suitable copolymeric polycarboxylates are particularly those of acrylic acid with methacrylic acid and of acrylic acid or methacrylic acid with maleic acid. Copolymers of acrylic acid with maleic acid, which comprise 50 to 90 wt. % acrylic acid and 50 to 10 wt. % maleic acid, have proven to be particularly suitable. Their relative molecular weight, based on free acids, generally ranges from 2 000 to 70 000 g/mol, preferably 20 000 to 50 000 g/mol and especially 30 000 to 40 000 g/mol.

The (co)polymeric polycarboxylate content of the automatic dishwashing agents is preferably from 0.5 to 20 wt. %, in particular from 3 to 10 wt. %.

Crystalline layer-forming silicates of the general formula NaMSiₓO₂ₓ₊₁.y(H₂O) are preferably employed, wherein M represents sodium or hydrogen, x is a number from 1.9 to 22, preferably 1.9 to 4, wherein particularly preferred values for x are 2, 3 or 4, and y stands for a number from 0 to 33, preferably from 0 to 20.

Beside the citrates, the phosphates have proved to be the most effective builders in regard to the cleaning power. In the washing and cleaning agent industry, among the many commercially available phosphates, the alkali metal phosphates are the most important and pentasodium or pentapotassium triphosphates (sodium or potassium tripolyphosphate) are particularly preferred.

“Alkali metal phosphates” is the collective term for the alkali metal (more particularly sodium and potassium) salts of the various phosphoric acids, in which metaphosphoric acids (HPO₃)ₙ and orthophosphoric acid (H₃PO₄) and representatives of higher molecular weight can be differentiated. In this regard, the phosphates combine many advantages: they act as alkalinity sources, prevent lime deposits on machine parts or lime incrustations in fabrics and, in addition, contribute towards the cleansing power.

The industrially important phosphates are the pentasodium triphosphate, Na₅P₃O₁₀ (sodium tripolyphosphate) as well as the corresponding potassium salt pentapotassium triphosphate K₅P₃O₁₀ (potassium tripolyphosphate). According to the invention, the sodium potassium tripolyphosphates are again preferably employed.

In the context of the present invention, if phosphates are incorporated as the active washing or cleaning substances in washing or cleaning agents, then preferred agents comprise this/these phosphate(s), preferably alkali metal phosphate(s), particularly preferably pentasodium or pentapotassium triphosphate (sodium or potassium triphosphate) in quantities of 2 to 40 wt. %, preferably 2 to 30 wt. % and especially 3 to 25 wt. %, each based on the weight of the washing or cleaning agent.

Other useful builders are amorphous sodium silicates with a modulus (Na₂O:SiO₂ ratio) of 1:2 to 1:3.3, preferably 1:2 to 1:2.8 and more preferably 1:2 to 1:2.6, which preferably dissolve with a delay and exhibit secondary wash cycle properties.

In preferred inventive automatic dishwashing agents the silicates content, based on the total weight of the automatic dishwashing agent, is limited to quantities below 10 wt. %, preferably below 5 wt. % and in particular below 2 wt. %. Particularly preferred inventive automatic dishwashing agents are silicate-free.

Naturally, the inventive automatic dishwashing agents can comprise the abovementioned builders both in the form of individual substances as well as in the form of mixtures of two, three, four or more builders.

Liquid automatic dishwashing agents are particularly preferred, wherein the dishwashing agent comprises at least two builders from the group of the phosphates, carbonates and citrates, wherein the weight fraction of these builders, based on the total weight of the dishwashing agent, is preferably 2 to 50 wt. %, preferably 5 to 40 wt. % and especially 10 to 30 wt. %. The combination of two or more builders from the abovementioned group has proven advantageous for the cleaning and rinsing power of the inventive automatic dishwashing agent.

The washing or cleaning agent preparation A comprises a complexing agent as the second key ingredient. The weight fraction of the complexing agent in the total weight of the inventive washing or cleaning preparation A is preferably between 2 to 60 wt. %, preferably 4 to 55 wt. % and especially 8 to 50 wt. %.

The phosphonates form a first group of preferred complexing agents. Besides the 1-hydroxyethane-1,1-diphosphonic acid, the phosphonate complexants include a series of different compounds such as for example diethylenetriamine penta(methylene phosphonic acid) (DTPMP). Hydroxyalkane phosphonates or aminoalkane phosphonates are particularly preferred in this application. Among the hydroxyalkane phosphonates, 1-hydroxyethane-1,1-diphosphonate (HEDP) is of particular importance as the cobuilder. It is normally added as the sodium salt, the disodium salt reacting neutral and the tetrasodium salt reacting alkaline (pH 9). Ethylenediamine tetramethylene phosphonate (EDTMP), diethylenetriamine pentamethylene phosphonate (DTPMP) and their higher homologs are preferably chosen as the aminoalkane phosphonates. They are preferably added in the form of the neutral-reacting sodium salts, e.g. as the hexasodium salt of EDTMP or as the hepta and octasodium salt of DTPMP. Of the class of phosphonates, HEDP is preferably used as the builder. The aminoalkane phosphonates additionally possess a pronounced ability to complex heavy metals. Accordingly, it can be preferred, particularly where the agents also contain bleach, to use aminoalkane phosphonates, particularly DTPMP, or mixtures of the cited phosphonates.

In the context of this application, a preferred washing or cleaning agent preparation A comprises one or more phosphonate(s) from the group: a) aminotrimethylene phosphonic acid (ATMP) and/or salts thereof; b) ethylenediamine tetra(methylene phosphonic acid) (EDTMP) and/or salts thereof; c) diethylenetriamine penta(methylene phosphonic acid) (DTMP) and/or salts thereof; d) 1-hydroxyethane-1,1-diphosphonic acid (HEDP) and/or salts thereof; e) 2-phosphonobutane-1,2,4-tricarboxylic acid (PBTC) and/or salts thereof; f) hexamethylenediamine tetra(methylene phosphonic acid) (HDTMP) and/or salts thereof; and g) nitrilotri(methylene phosphonic acid) (NTMP) and/or salts thereof.

Particularly preferred washing or cleaning agent preparations A comprise 1-hydroxyethane-1,diphosphonic acid (HEDP) or diethylenetriamine penta(methylene phosphonic acid) (DTPMP) as the phosphonates.

Of course the inventive automatic dishwashing agents can comprise two or more different phosphonates.

The weight fraction of the phosphonates in the total weight of the inventive washing or cleaning agent preparations A is advantageously 1 to 8 wt. %, preferably 1.2 to 6 wt. % and especially 1.5 to 4 wt. %.

Particularly preferred washing or cleaning agent presentation forms are those,

wherein the complexing agent a2) is selected from the group nitrilotriacetic acid, hydroxyethylethylenediamine triacetic acid, ethylenediamine tetraacetic acid, diethylenetriamine pentaacetic acid, methyl glycine diacetic acid, glutamic acid diacetic acid, imino disuccinic acid, hydroxyimino disuccinic acid, ethylenediamine disuccinic acid, aspartic acid diacetic acid, hydroxyethane-1,1-diphosphonic acid or diethylenetriamine penta(methylene phosphonic acid) as well as their salts.

The inventive washing or cleaning agent preparations A can comprise ethylenediamine disuccinic acid (EDDS) as an additional complexing agent, wherein preferred washing or cleaning agent preparations A comprise, based on their total weight, 3.0 to 35 wt. %, preferably 4.0 to 30 wt. % and especially 8.0 to 25 wt. % ethylenediamine disuccinic acid.

The term, “ethylenediamine disuccinic acid” (EDDS) also includes, in addition to the free acids, the salts thereof, for example their sodium or potassium salts. In regard to the weight fraction of the ethylenediamine disuccinic acid employed in the inventive agents, should the acid salt be added then the weight fraction of the free acid is applied, i.e. the weight fraction of the salt has to be converted into the weight fraction of the acid.

In a preferred inventive embodiment, in particular for use as a fabric washing agent, the washing or cleaning agent preparation A additionally comprises at least one surfactant, especially selected from anionic, non-ionic, zwitterionic and amphoteric surfactants. Alternatively, the surfactants can also be comprised in a washing or cleaning agent preparation that differs from the washing or cleaning agent preparation A and B. Surfactants, in so far as they are employed, are comprised in an inventive washing or cleaning agent preparation A, preferably in an amount of up to 40 wt. %, particularly 2 to 40 wt. % or 4 to 40 wt. %, particularly preferably in an amount of 5 to 35 wt. %, in particular 10 to 30 wt. %.

Preferred non-ionic surfactants are alkoxylated, advantageously ethoxylated, particularly primary alcohols preferably containing 8 to 18 carbon atoms and, on average, 1 to 12 moles of ethylene oxide (EO) per mole of alcohol, in which the alcohol group may be linear or, preferably, methyl-branched in the 2-position or may contain e.g. linear and methyl-branched groups in the form of the mixtures typically present in Oxo alcohol groups. In particular, however, alcohol ethoxylates that contain linear alcohol groups of natural origin containing 12 to 18 carbon atoms, e.g. from coco-, palm-, tallow- or oleyl alcohol, and an average of 2 to 8 EO per mole alcohol are preferred. Exemplary preferred ethoxylated alcohols include C₁₂₋₁₄ alcohols with 3 EO, 4EO or 7EO, C₉₋₁₁ alcohol with 7 EO, C₁₃₋₁₅ alcohols with 3 EO, 5 EO, 7 EO or 8 EO, C₁₂₋₁₈ alcohols with 3EO, 5EO or 7EO and mixtures thereof, such as mixtures of C₁₂₋₁₄ alcohol with 3 EO and C₁₂₋₁₈ alcohol with 7 EO. The cited degrees of ethoxylation constitute statistically average values that can be a whole or a fractional number for a specific product. Preferred alcohol ethoxylates have a narrowed homolog distribution (narrow range ethoxylates, NRE). In addition to these non-ionic surfactants, fatty alcohols with more than 12 EO can also be used. Examples of these are tallow fatty alcohol with 14 EO, 25 EO, 30 EO or 40 EO. Also, non-ionic surfactants that comprise the EO and PO groups together in the molecule are employable according to the invention. Here, block copolymers with EO-PO blocks or PO-EO blocks can be added, but also EO-PO-EO copolymers or PO-EO-PO copolymers. Of course, mixed alkoxylated non-ionic surfactants can also be used, in which EO- and PO-units are not in blocks but rather distributed statistically. Such products can be obtained by the simultaneous action of ethylene oxide and propylene oxide on fatty alcohols.

Furthermore, as additional non-ionic surfactants, alkyl glycosides that satisfy the general Formula RO(G)ₓ can be added, where R means a primary linear or methyl-branched, particularly 2-methyl-branched, aliphatic group containing 8 to 22 and preferably 12 to 18 carbon atoms and G stands for a glycose unit containing 5 or 6 carbon atoms, preferably glucose. The degree of oligomerization x, which defines the distribution of monoglycosides and oligoglycosides, is any number between 1 and 10, preferably 1.2 to 1.4. Alkyl glycosides are known, mild surfactants.

Another class of preferred non-ionic surfactants which may be used, either as the sole non-ionic surfactant or in combination with other non-ionic surfactants, are alkoxylated, preferably ethoxylated or ethoxylated and propoxylated fatty acid alkyl esters preferably containing 1 to 4 carbon atoms in the alkyl chain, in particular fatty acid methyl esters.

Non-ionic surfactants of the amine oxide type, for example N-cocoalkyl-N,N-dimethylamine oxide and N-tallow alkyl-N,N-dihydroxyethylamine oxide, and the fatty acid alkanolamides may also be suitable. The quantity in which these non-ionic surfactants are used is preferably no more than the quantity in which the ethoxylated fatty alcohols are used and, particularly no more than half that quantity.

Other suitable surfactants are polyhydroxyfatty acid amides corresponding to the Formula (I),

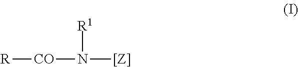

in which RCO stands for an aliphatic acyl group with 6 to 22 carbon atoms, R¹ for hydrogen, an alkyl or hydroxyalkyl group with 1 to 4 carbon atoms and [Z] for a linear or branched polyhydroxyalkyl group with 3 to 10 carbon atoms and 3 to 10 hydroxyl groups. The polyhydroxyfatty acid amides are known substances, which may normally be obtained by reductive amination of a reducing sugar with ammonia, an alkylamine or an alkanolamine and subsequent acylation with a fatty acid, a fatty acid alkyl ester or a fatty acid chloride.

The group of polyhydroxyfatty acid amides also includes compounds corresponding to the Formula (II),

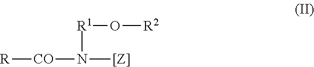

in which R is a linear or branched alkyl or alkenyl group containing 7 to 12 carbon atoms, R¹ is a linear, branched or cyclic alkyl group or an aryl group containing 2 to 8 carbon atoms and R² is a linear, branched or cyclic alkyl group or an aryl group or an oxyalkyl group containing 1 to 8 carbon atoms, C₁₋₄ alkyl or phenyl groups being preferred, and [Z] is a linear polyhydroxyalkyl group, of which the alkyl chain is substituted by at least two hydroxyl groups, or alkoxylated, preferably ethoxylated or propoxylated derivatives of that group.

Group [Z] in Formula (II) is preferably obtained by reductive amination of a sugar, for example glucose, fructose, maltose, lactose, galactose, mannose or xylose. The N-alkoxy- or N-aryloxy-substituted compounds may then be converted into the required polyhydroxyfatty acid amides by reaction with fatty acid methyl esters in the presence of an alkoxide as catalyst.

In a preferred embodiment, the content of non-ionic surfactants in the washing or cleaning agent preparation A is 5 to 30 wt. %, preferably 7 to 20 wt. % and particularly 9 to 15 wt. %, based on the total amount of the washing or cleaning agent preparation A.

The washing or cleaning agent preparation A can also comprise anionic surfactants in addition to the non-ionic surfactants. Exemplary suitable anionic surfactants are those of the sulfonate and sulfate type. Suitable surfactants of the sulfonate type are, advantageously C₉₋₁₃ alkylbenzene sulfonates, olefin sulfonates, i.e. mixtures of alkene- and hydroxyalkane sulfonates and disulfonates, as are obtained, for example, from Cₗ₂₋₁₈ monoolefins having a terminal or internal double bond, by sulfonation with gaseous sulfur trioxide and subsequent alkaline or acidic hydrolysis of the sulfonation products. Alkane sulfonates, obtained for example from C₁₂₋₁₈ alkanes by sulfochlorination or sulfoxidation with subsequent hydrolysis or neutralization, are also suitable. The esters of α-sulfofatty acids (ester sulfonates), e.g. the α-sulfonated methyl esters of hydrogenated coco-, palm nut- or tallow fatty acids are likewise suitable.

Further suitable anionic surfactants are sulfated fatty acid esters of glycerin. The fatty acid esters of glycerin are understood to mean the mono-, di- and triesters and also mixtures of them, such as those obtained by the esterification of a monoglycerin with 1 to 3 moles fatty acid or by the transesterification of triglycerides with 0.3 to 2 moles glycerin. Preferred sulfated fatty acid esters of glycerin in this case are the sulfated products of saturated fatty acids containing 6 to 22 carbon atoms, for example caproic acid, caprylic acid, capric acid, myristic acid, lauric acid, palmitic acid, stearic acid or behenic acid.

Preferred alk(en)yl sulfates are the alkali metal and especially sodium salts of the sulfuric acid half-esters derived from the C₁₂-C₁₈ fatty alcohols, for example from coconut butter alcohol, tallow alcohol, lauryl, myristyl, cetyl or stearyl alcohol or from C₁₀-C₂₀ Oxo alcohols and those half-esters of secondary alcohols of these chain lengths. Additionally preferred are alk(en)yl sulfates of the said chain lengths, which contain a synthetic, straight-chained alkyl group produced on a petrochemical basis and which show similar degradation behaviour to the suitable compounds based on fat chemical raw materials. The C₁₂-C₁₆ alkyl sulfates and C₁₂-C₁₅ alkyl sulfates as well as C₁₄-C₁₅ alkyl sulfates are preferred on the grounds of washing performance. 2,3-Alkyl sulfates, which can be obtained from the Shell Oil Company under the trade name DAN®, are also suitable anionic surfactants.

Sulfuric acid mono-esters derived from straight-chain or branched C₇₋₂₁ alcohols ethoxylated with 1 to 6 moles ethylene oxide are also suitable, for example 2-methyl-branched C₉₋₁₁ alcohols with an average of 3.5 mole ethylene oxide (EO) or C₁₂₋₁₈ fatty alcohols with 1 to 4 EO. Due to their high foaming behavior, they are only used in fairly small quantities in cleaning agents, for example in amounts of 1 to 5% by weight.

Other suitable anionic surfactants are also the salts of alkyl sulfosuccinic acid, which are also referred to as sulfosuccinates or esters of sulfosuccinic acid and the monoesters and/or diesters of sulfosuccinic acid with alcohols, preferably fatty alcohols and especially ethoxylated fatty alcohols. Preferred sulfosuccinates comprise C₈₋₁₈ fatty alcohol groups or mixtures of them. Especially preferred sulfosuccinates comprise a fatty alcohol group derived from ethoxylated fatty alcohols and may be considered as non-ionic surfactants (see description below). Once again the particularly preferred sulfosuccinates are those, whose fatty alcohol groups are derived from ethoxylated fatty alcohols with narrow range homolog distribution. It is also possible to use alk(en)ylsuccinic acids with preferably 8 to 18 carbon atoms in the alk(en)yl chain, or salts thereof.

Particularly preferred anionic surfactants are soaps. Saturated and unsaturated fatty acid soaps are suitable, such as the salts of lauric acid, myristic acid, palmitic acid, stearic acid, (hydrogenated) erucic acid and behenic acid, and especially soap mixtures derived from natural fatty acids such as coconut oil fatty acid, palm kernel oil fatty acid, olive oil fatty acid or tallow fatty acid.

Anionic surfactants, including the soaps, may be in the form of their sodium, potassium or ammonium salts or as soluble salts of organic bases, such as mono-, di- or triethanolamine. Preferably, the anionic surfactants are in the form of their sodium or potassium salts, especially in the form of the sodium salts.

In a preferred embodiment, the content of anionic surfactants in the washing or cleaning agent preparation A is 0.1 to 30 wt. %, preferably 2 to 20 wt. %, based on the total amount of the washing or cleaning agent preparation A.

The washing or cleaning agent preparation A preferably has a pH between 9 and 14, especially 9 and 12. The pH can be adjusted, when necessary, by means of appropriate pH adjustors, especially sodium hydroxide.

The composition of some exemplary inventive washing or cleaning agent presentation forms, which contain the washing and cleaning agent preparation A as well as the washing or cleaning agent preparation B, can be found in the following TABLES 1-10.

Tables 1-10: Exemplary Packaged Washing or Cleaning Agents

TABLE 1

| | Formula- | Formula- | Formula- | Formula- |
|---|---|---|---|---|
| | tion 1 | tion 2 | tion 3 | tion 4 |
| | [wt. %] | [wt. %] | [wt. %] | [wt. %] |
| Ingredients in W. & C. | | | | |
| Preparation A | | | | |
| Builder | 2 to 50 | 2 to 50 | 6 to 45 | 10 to 40 |
| Complexing agent | 2 to 60 | 4 to 55 | 4 to 55 | 8 to 60 |
| Misc | ad 100 | ad 100 | ad 100 | ad 100 |
| Ingredients in W. & C. | | | | |
| Preparation B | | | | |
| Enzyme preparation | at least 5 | at least 5 | at least 5 | at least 5 |
| Phosphate | <10 | <10 | <10 | <10 |
| Complexing agent | <2.5 | <2.5 | <2.5 | <2.5 |
| Misc | ad 100 | ad 100 | ad 100 | ad 100 |

TABLE 2

| | Formula- | Formula- | Formula- | Formula- |
|---|---|---|---|---|
| | tion 5 | tion 6 | tion 7 | tion 8 |
| | [wt. %] | [wt. %] | [wt. %] | [wt. %] |
| Ingredients in W. & C. | | | | |
| Preparation A | | | | |
| (Hydrogen) carbonate | 2 to 30 | 2 to 30 | 3 to 20 | 4 to 15 |
| Citrate | 2 to 40 | 5 to 30 | 5 to 30 | 7 to 20 |
| Complexing agent | 2 to 60 | 4 to 55 | 4 to 55 | 8 to 60 |
| Misc | ad 100 | ad 100 | ad 100 | ad 100 |
| Ingredients in W. & C. | | | | |
| Preparation B | | | | |
| Enzyme preparation | at least 5 | at least 5 | at least 5 | at least 5 |
| Phosphate | <10 | <10 | <10 | <10 |
| Complexing agent | <2.5 | <2.5 | <2.5 | <2.5 |
| Misc | ad 100 | ad 100 | ad 100 | ad 100 |

TABLE 3

| | Formula- | Formula- | Formula- | Formula- |
|---|---|---|---|---|
| | tion 9 | tion 10 | tion 11 | tion 12 |
| | [wt. %] | [wt. %] | [wt. %] | [wt. %] |
| Ingredients in W. & C. | | | | |
| Preparation A | | | | |
| Builder | 2 to 50 | 2 to 50 | 6 to 45 | 10 to 40 |
| EDDS | 3 to 35 | 3 to 35 | 4 to 30 | 8 to 25 |
| Misc | ad 100 | ad 100 | ad 100 | ad 100 |
| Ingredients in W. & C. | | | | |
| Preparation B | | | | |
| Enzyme preparation | at least 5 | at least 5 | at least 5 | at least 5 |
| Phosphate | <10 | <10 | <10 | <10 |
| Complexing agent | <2.5 | <2.5 | <2.5 | <2.5 |
| Misc | ad 100 | ad 100 | ad 100 | ad 100 |

TABLE 4

| | Formula- | Formula- | Formula- | Formula- |
|---|---|---|---|---|
| | tion 13 | tion 14 | tion 15 | tion 16 |
| | [wt. %] | [wt. %] | [wt. %] | [wt. %] |
| Ingredients in W. & C. | | | | |
| Preparation A | | | | |
| (Hydrogen) carbonate | 2 to 30 | 2 to 30 | 3 to 20 | 4 to 15 |
| Citrate | 2 to 40 | 5 to 30 | 5 to 30 | 7 to 20 |
| EDDS | 3 to 35 | 3 to 35 | 4 to 30 | 8 to 25 |
| Misc | ad 100 | ad 100 | ad 100 | ad 100 |
| Ingredients in W. & C. | | | | |
| Preparation B | | | | |
| Enzyme preparation | at least 5 | at least 5 | at least 5 | at least 5 |
| Phosphate | <10 | <10 | <10 | <10 |
| Complexing agent | <2.5 | <2.5 | <2.5 | <2.5 |
| Misc | ad 100 | ad 100 | ad 100 | ad 100 |

TABLE 5

| | Formula- | Formula- | Formula- | Formula- |
|---|---|---|---|---|
| | tion 17 | tion 18 | tion 19 | tion 20 |
| | [wt. %] | [wt. %] | [wt. %] | [wt. %] |
| Ingredients in W. & C. | | | | |
| Preparation A | | | | |
| Builder | 2 to 50 | 2 to 50 | 6 to 45 | 10 to 40 |
| Phosphonate | 1 to 8 | 1.2 to 6 | 1.2 to 6 | 1.5 to 4 |
| Misc | ad 100 | ad 100 | ad 100 | ad 100 |
| Ingredients in W. & C. | | | | |
| Preparation B | | | | |
| Enzyme preparation | at least 5 | at least 5 | at least 5 | at least 5 |
| Phosphate | <10 | <10 | <10 | <10 |
| Complexing agent | <2.5 | <2.5 | <2.5 | <2.5 |
| Misc | ad 100 | ad 100 | ad 100 | ad 100 |

TABLE 6

| | Formula- | Formula- | Formula- | Formula- |
|---|---|---|---|---|
| | tion 21 | tion 22 | tion 23 | tion 24 |
| | [wt. %] | [wt. %] | [wt. %] | [wt. %] |
| Ingredients in W. & C. | | | | |
| Preparation A | | | | |
| (Hydrogen) carbonate | 2 to 30 | 2 to 30 | 3 to 20 | 4 to 15 |
| Citrate | 2 to 40 | 5 to 30 | 5 to 30 | 7 to 20 |
| Phosphonate | 1 to 8 | 1.2 to 6 | 1.2 to 6 | 1.5 to 4 |
| Misc | ad 100 | ad 100 | ad 100 | ad 100 |
| Ingredients in W. & C. | | | | |
| Preparation B | | | | |
| Enzyme preparation | at least 5 | at least 5 | at least 5 | at least 5 |
| Phosphate | <10 | <10 | <10 | <10 |
| Complexing agent | <2.5 | <2.5 | <2.5 | <2.5 |
| Misc | ad 100 | ad 100 | ad 100 | ad 100 |

TABLE 7

| | Formula- | Formula- | Formula- | Formula- |
|---|---|---|---|---|
| | tion 25 | tion 26 | tion 27 | tion 28 |
| | [wt. %] | [wt. %] | [wt. %] | [wt. %] |
| Ingredients in W. & C. | | | | |
| Preparation A | | | | |
| Builder | 2 to 50 | 2 to 50 | 6 to 45 | 10 to 40 |
| EDDS | 3 to 35 | 3 to 35 | 4 to 30 | 8 to 25 |
| Phosphonate | 1 to 8 | 1.2 to 6 | 1.2 to 6 | 1.5 to 4 |
| Misc | ad 100 | ad 100 | ad 100 | ad 100 |
| Ingredients in W. & C. | | | | |
| Preparation B | | | | |
| Enzyme preparation | at least 5 | at least 5 | at least 5 | at least 5 |
| Phosphate | <10 | <10 | <10 | <10 |
| Complexing agent | <2.5 | <2.5 | <2.5 | <2.5 |
| Misc | ad 100 | ad 100 | ad 100 | ad 100 |

TABLE 8

| | Formula- | Formula- | Formula- | Formula- |
|---|---|---|---|---|
| | tion 29 | tion 30 | tion 31 | tion 32 |
| | [wt. %] | [wt. %] | [wt. %] | [wt. %] |
| Ingredients in W. & C. | | | | |
| Preparation A | | | | |
| (Hydrogen) carbonate | 2 to 30 | 2 to 30 | 3 to 20 | 4 to 15 |
| Citrate | 2 to 40 | 5 to 30 | 5 to 30 | 7 to 20 |
| EDDS | 3 to 35 | 3 to 35 | 4 to 30 | 8 to 25 |
| Phosphonate | 1 to 8 | 1.2 to 6 | 1.2 to 6 | 1.5 to 4 |
| Misc | ad 100 | ad 100 | ad 100 | ad 100 |
| Ingredients in W. & C. | | | | |
| Preparation B | | | | |
| Enzyme preparation | at least 5 | at least 5 | at least 5 | at least 5 |
| Phosphate | <10 | <10 | <10 | <10 |
| Complexing agent | <2.5 | <2.5 | <2.5 | <2.5 |
| Misc | ad 100 | ad 100 | ad 100 | ad 100 |

TABLE 9

| | Formula- | Formula- | Formula- | Formula- |
|---|---|---|---|---|
| | tion 33 | tion 34 | tion 35 | tion 36 |
| | [wt. %] | [wt. %] | [wt. %] | [wt. %] |
| Ingredients in W. & C. | | | | |
| Preparation A | | | | |
| Builder | 2 to 50 | 2 to 50 | 6 to 45 | 10 to 40 |
| Complexing agent | 2 to 60 | 4 to 55 | 4 to 55 | 8 to 60 |
| Surfactants | 2 to 40 | 4 to 40 | 5 to 35 | 5 to 35 |
| Misc | ad 100 | ad 100 | ad 100 | ad 100 |
| Ingredients in W. & C. | | | | |
| Preparation B | | | | |
| Enzyme preparation | at least 5 | at least 5 | at least 5 | at least 5 |
| Phosphate | <10 | <10 | <10 | <10 |
| Complexing agent | <2.5 | <2.5 | <2.5 | <2.5 |
| Misc | ad 100 | ad 100 | ad 100 | ad 100 |

TABLE 10

| | Formula- | Formula- | Formula- | Formula- |
|---|---|---|---|---|
| | tion 37 | tion 38 | tion 39 | tion 40 |
| | [wt. %] | [wt. %] | [wt. %] | [wt. %] |
| Ingredients in W. & C. | | | | |
| Preparation A | | | | |
| (Hydrogen) carbonate | 0 to 30 | 0 to 30 | 2 to 20 | 2 to 20 |
| Citrate | 2 to 40 | 4 to 30 | 2 to 40 | 4 to 30 |
| Complexing agent | 2 to 40 | 2 to 30 | 2 to 40 | 2 to 30 |
| Non-ionic Surfactants | 2 to 40 | 4 to 40 | 2 to 40 | 4 to 40 |
| Misc | ad 100 | ad 100 | ad 100 | ad 100 |
| Ingredients in W. & C. | | | | |
| Preparation B | | | | |
| Enzyme preparation | at least 5 | at least 5 | at least 5 | at least 5 |
| Phosphate | <10 | <10 | <10 | <10 |
| Complexing agent | <2.5 | <2.5 | <2.5 | <2.5 |
| Misc | ad 100 | ad 100 | ad 100 | ad 100 |

The washing or cleaning agent preparations B according to the invention comprise at least one active washing or cleaning enzyme as their first key ingredient. The weight fraction of the active washing or cleaning enzyme in the total weight of the washing or cleaning agent preparation is advantageously between 5 and 80 wt. %, preferably between 5 and 60 wt. %, particularly preferably between 10 and 50 wt. % and especially between 10 and 30 wt. %.

Particularly preferred added enzymes particularly include proteases, amylases, lipases, hemicellulases, cellulases, perhydrolases or oxidoreductases, as well as preferably their mixtures. In principle, these enzymes are of natural origin; improved variants based on the natural molecules are available for use in washing or cleaning agents and accordingly they are preferably employed. The washing or cleaning agents preferably comprise enzymes in total quantities of 1×10⁻⁶ to 5 wt. % based on active protein. The protein concentration can be determined using known methods, for example the BCA process or the biuret process.

The stabilizing action according to the invention was observed to a particular degree with the amylases, proteases, cellulases and mannanases; therefore liquid washing or cleaning agent preparations B according to the invention comprising an active washing or cleaning enzyme from the group of the amylases and/or proteases and/or cellulases and/or mannanases, are preferred.

Preferred proteases are those of the subtilisin type. Examples of these are the subtilisins BPN′ and Carlsberg as well as their further developed forms, the protease PB92, the subtilisins 147 and 309, the alkaline protease from Bacillus lentus, subtilisin DY and those enzymes of the subtilases, no longer however classified in the stricter sense as subtilisins: thermitase, proteinase K and the proteases TW3 and TW7.

Preferred liquid washing or cleaning agent preparations B according to the invention comprise 5 to 50 wt. %, preferably 7 to 40 wt. % and in particular 10 to 30 wt. % protease preparations, relative to the total weight of the washing or cleaning agent preparation.

Washing or cleaning agent preparations A that, relative to their total weight, comprise 15 to 25 wt. % of protease preparations, are particularly preferred.

Examples of useable amylases according to the invention are the α-amylases from Bacillus licheniformis, from B. amyloliquefaciens, from B. stearothermophilus, from Aspergillus niger and A. oryzae as well as their improved further developments for use in washing and cleaning agents. Moreover, for this purpose, attention should be drawn to the α-amylase from Bacillus sp. A 7-7 (DSM 12368) and the cyclodextrin-glucanotransferase (CGTase) from B. agaradherens (DSM 9948).

Inventively preferred liquid washing or cleaning agent preparations B comprise 0.1 to 30 wt. %, preferably 1.0 to 25 wt. % and in particular 2.0 to 20 wt. % of amylase preparations, relative to the total weight of the washing or cleaning agent preparation. Washing or cleaning agent preparations B that, relative to their total weight, comprise 4.0 to 16 wt. % of amylase preparations are particularly preferred.

Additional inventively preferred liquid washing or cleaning agent preparations B comprise 0.1 to 30 wt. %, preferably 1.0 to 25 wt. % and in particular 2.0 to 20 wt. % of cellulase preparations, relative to the total weight of the washing or cleaning agent preparation.

Additional inventively preferred liquid washing or cleaning agent preparations B comprise 0.1 to 30 wt. %, preferably 1.0 to 25 wt. % and in particular 2.0 to 20 wt. % of mannanase preparations, relative to the total weight of the washing or cleaning agent preparation.

According to the invention, lipases or cutinases can also be incorporated, particularly due to their triglyceride cleaving activities, but also in order to produce in situ peracids from suitable precursors. These include for example the available or further developed lipases originating from Humicola lanuginosa (Thermomyces lanuginosus), particularly those with the amino acid substitution D96L. Moreover, suitable cutinases, for example are those that were originally isolated from Fusarium solani pisi and Humicola insolens. Further suitable lipases or cutinases are those whose starting enzymes were originally isolated from Pseudomonas mendocina and Fusarium solanii.

Additional inventively preferred liquid washing or cleaning agent preparations B comprise 0.1 to 30 wt. %, preferably 1.0 to 25 wt. % and in particular 2.0 to 20 wt. % of lipase preparations, relative to the total weight of the washing or cleaning agent preparation.

In addition, enzymes, which are summarized under the term hemicellulases, can be added. In addition to the abovementioned mannanases, they include for example xanthanlyases, pectinlyases pectinases), pectinesterases, pectatlyases, xyloglucanases (=xylanases), pullulanases and β-glucanases.

To increase the bleaching action, oxidoreductases, for example oxidases, oxygenases, catalases, peroxidases, such as halo-, chloro-, bromo-, lignin-, glucose- or manganese-peroxidases, dioxygenases or laccases (phenoloxidases, polyphenoloxidases) can be incorporated according to the invention. Advantageously, additional, preferably organic, particularly preferably aromatic compounds are added that interact with the enzymes to enhance the activity of the relevant oxidoreductases (enhancers) or to facilitate the electron flow (mediators) between the oxidizing enzymes and the stains over strongly different redox potentials.

Active washing or cleaning enzymes, in particular proteases and amylases, are generally not made available in the form of the pure protein but rather in the form of stabilized, storable and transportable preparations. These prefabricated preparations include, for example, solid preparations obtained by granulation, extrusion or lyophilisation, or particularly for liquid compositions or gel-type compositions, enzyme solutions, advantageously as highly concentrated as possible, of low moisture content and/or mixed with stabilizers or further adjuvants.

Alternatively the enzymes, both for the solid as well as for the liquid application form, can be encapsulated, for example by spray drying or extrusion of the enzyme solution together with a preferably natural polymer or in the form of capsules, for example those, in which the enzyme is embedded in a solidified gel, or in those of the core-shell type, in which an enzyme-containing core is coated with a water-, air- and/or chemical-impervious protective layer. Further active principles, for example stabilizers, emulsifiers, pigments, bleaches or colorants can be applied in additional layers. Such capsules are made using known methods, for example by vibratory granulation or roll compaction or by fluidized bed processes. Advantageously, these types of granulates, for example with a coated polymeric film former, are dust-free and as a result of the coating are storage stable.

In addition, it is possible to formulate two or more enzymes together, so that a single granulate exhibits a plurality of enzymatic activities.

As the preceding examples demonstrate, the enzyme protein forms only a fraction of the total weight of customary enzyme preparations. Inventively preferred added protease and amylase preparations comprise between 0.1 and 40 wt. %, preferably between 0.2 and 30 wt. %, particularly preferably between 0.4 and 20 wt. % and especially between 0.8 and 10 wt. % of the enzyme protein.

A plurality of enzymes and/or enzyme preparations, preferably liquid protease preparations and/or amylase preparations and/or cellulase preparations and/or mannanase preparations, are preferably added.

A preferred pH of the inventive washing or cleaning agent preparations B is between 6 and 9.

The compositions of exemplary inventive washing or cleaning agent presentation forms, which contain the washing and cleaning agent preparation A as well as the washing or cleaning agent preparation B, may be found in the following TABLES 11-20.

Tables 11-20: Exemplary Packaged Washing or Cleaning Agents

TABLE 11

| | Formula- | Formula- | Formula- | Formula- |
|---|---|---|---|---|
| | tion 41 | tion 42 | tion 43 | tion 44 |
| | [wt. %] | [wt. %] | [wt. %] | [wt. %] |
| Ingredients in W. & C. | | | | |
| Preparation A | | | | |
| Builder | 2 to 50 | 2 to 50 | 6 to 45 | 10 to 40 |
| Complexing agent | 2 to 60 | 4 to 55 | 4 to 55 | 8 to 60 |
| Misc | ad 100 | ad 100 | ad 100 | ad 100 |
| Ingredients in W. & C. | | | | |
| Preparation B | | | | |
| Enzyme preparation | 5 to 80 | 5 to 50 | 10 to 50 | 10 to 30 |
| Phosphate | <10 | <10 | <10 | <10 |
| Complexing agent | <2.5 | <2.5 | <2.5 | <2.5 |
| Misc | ad 100 | ad 100 | ad 100 | ad 100 |

TABLE 12

| | Formula- | Formula- | Formula- | Formula- |
|---|---|---|---|---|
| | tion 45 | tion 46 | tion 47 | tion 48 |
| | [wt. %] | [wt. %] | [wt. %] | [wt. %] |
| Ingredients in W. & C. | | | | |
| Preparation A | | | | |
| (Hydrogen) carbonate | 2 to 30 | 2 to 30 | 3 to 20 | 4 to 15 |
| Citrate | 2 to 40 | 5 to 30 | 5 to 30 | 7 to 20 |
| Complexing agent | 2 to 60 | 4 to 55 | 4 to 55 | 8 to 60 |
| Misc | ad 100 | ad 100 | ad 100 | ad 100 |
| Ingredients in W. & C. | | | | |
| Preparation B | | | | |
| Enzyme preparation | 5 to 80 | 5 to 50 | 10 to 50 | 10 to 30 |
| Phosphate | <10 | <10 | <10 | <10 |
| Complexing agent | <2.5 | <2.5 | <2.5 | <2.5 |
| Misc | ad 100 | ad 100 | ad 100 | ad 100 |

TABLE 13

| | Formula- | Formula- | Formula- | Formula- |
|---|---|---|---|---|
| | tion 49 | tion 50 | tion 51 | tion 52 |
| | [wt. %] | [wt. %] | [wt. %] | [wt. %] |
| Ingredients in W. & C. | | | | |
| Preparation A | | | | |
| Builder | 2 to 50 | 2 to 50 | 6 to 45 | 10 to 40 |
| EDDS | 3 to 35 | 3 to 35 | 4 to 30 | 8 to 25 |
| Misc | ad 100 | ad 100 | ad 100 | ad 100 |
| Ingredients in W. & C. | | | | |
| Preparation B | | | | |
| Enzyme preparation | 5 to 80 | 5 to 50 | 10 to 50 | 10 to 30 |
| Phosphate | <10 | <10 | <10 | <10 |
| Complexing agent | <2.5 | <2.5 | <2.5 | <2.5 |
| Misc | ad 100 | ad 100 | ad 100 | ad 100 |

TABLE 14

| | Formula- | Formula- | Formula- | Formula- |
|---|---|---|---|---|
| | tion 53 | tion 54 | tion 55 | tion 56 |
| | [wt. %] | [wt. %] | [wt. %] | [wt. %] |
| Ingredients in W. & C. | | | | |
| Preparation A | | | | |
| (Hydrogen) carbonate | 2 to 30 | 2 to 30 | 3 to 20 | 4 to 15 |
| Citrate | 2 to 40 | 5 to 30 | 5 to 30 | 7 to 20 |
| EDDS | 3 to 35 | 3 to 35 | 4 to 30 | 8 to 25 |
| Misc | ad 100 | ad 100 | ad 100 | ad 100 |
| Ingredients in W. & C. | | | | |
| Preparation B | | | | |
| Enzyme preparation | 5 to 80 | 5 to 50 | 10 to 50 | 10 to 30 |
| Phosphate | <10 | <10 | <10 | <10 |
| Complexing agent | <2.5 | <2.5 | <2.5 | <2.5 |
| Misc | ad 100 | ad 100 | ad 100 | ad 100 |

TABLE 15

| | Formula- | Formula- | Formula- | Formula- |
|---|---|---|---|---|
| | tion 57 | tion 58 | tion 59 | tion 60 |
| | [wt. %] | [wt. %] | [wt. %] | [wt. %] |
| Ingredients in W. & C. | | | | |
| Preparation A | | | | |
| Builder | 2 to 50 | 2 to 50 | 6 to 45 | 10 to 40 |
| Phosphonate | 1 to 8 | 1.2 to 6 | 1.2 to 6 | 1.5 to 4 |
| Misc | ad 100 | ad 100 | ad 100 | ad 100 |
| Ingredients in W. & C. | | | | |
| Preparation B | | | | |
| Enzyme preparation | 5 to 80 | 5 to 50 | 10 to 50 | 10 to 30 |
| Phosphate | <10 | <10 | <10 | <10 |
| Complexing agent | <2.5 | <2.5 | <2.5 | <2.5 |
| Misc | ad 100 | ad 100 | ad 100 | ad 100 |

TABLE 16

| | Formula- | Formula- | Formula- | Formula- |
|---|---|---|---|---|
| | tion 61 | tion 62 | tion 63 | tion 64 |
| | [wt. %] | [wt. %] | [wt. %] | [wt. %] |
| Ingredients in W. & C. | | | | |
| Preparation A | | | | |
| (Hydrogen) carbonate | 2 to 30 | 2 to 30 | 3 to 20 | 4 to 15 |
| Citrate | 2 to 40 | 5 to 30 | 5 to 30 | 7 to 20 |
| Phosphonate | 1 to 8 | 1.2 to 6 | 1.2 to 6 | 1.5 to 4 |
| Misc | ad 100 | ad 100 | ad 100 | ad 100 |
| Ingredients in W. & C. | | | | |
| Preparation B | | | | |
| Enzyme preparation | 5 to 80 | 5 to 50 | 10 to 50 | 10 to 30 |
| Phosphate | <10 | <10 | <10 | <10 |
| Complexing agent | <2.5 | <2.5 | <2.5 | <2.5 |
| Misc | ad 100 | ad 100 | ad 100 | ad 100 |

TABLE 17

| | Formula- | Formula- | Formula- | Formula- |
|---|---|---|---|---|
| | tion 65 | tion 66 | tion 67 | tion 68 |
| | [wt. %] | [wt. %] | [wt. %] | [wt. %] |
| Ingredients in W. & C. | | | | |
| Preparation A | | | | |
| Builder | 2 to 50 | 2 to 50 | 6 to 45 | 10 to 40 |
| EDDS | 3 to 35 | 3 to 35 | 4 to 30 | 8 to 25 |
| Phosphonate | 1 to 8 | 1.2 to 6 | 1.2 to 6 | 1.5 to 4 |
| Misc | ad 100 | ad 100 | ad 100 | ad 100 |
| Ingredients in W. & C. | | | | |
| Preparation B | | | | |
| Enzyme preparation | 5 to 80 | 5 to 50 | 10 to 50 | 10 to 30 |
| Phosphate | <10 | <10 | <10 | <10 |
| Complexing agent | <2.5 | <2.5 | <2.5 | <2.5 |
| Misc | ad 100 | ad 100 | ad 100 | ad 100 |

TABLE 18

| | Formula- | Formula- | Formula- | Formula- |
|---|---|---|---|---|
| | tion 69 | tion 70 | tion 71 | tion 72 |
| | [wt. %] | [wt. %] | [wt. %] | [wt. %] |
| Ingredients in W. & C. | | | | |
| Preparation A | | | | |
| (Hydrogen) carbonate | 2 to 30 | 2 to 30 | 3 to 20 | 4 to 15 |
| Citrate | 2 to 40 | 5 to 30 | 5 to 30 | 7 to 20 |
| EDDS | 3 to 35 | 3 to 35 | 4 to 30 | 8 to 25 |
| Phosphonate | 1 to 8 | 1.2 to 6 | 1.2 to 6 | 1.5 to 4 |
| Misc | ad 100 | ad 100 | ad 100 | ad 100 |
| Ingredients in W. & C. | | | | |
| Preparation B | | | | |
| Enzyme preparation | 5 to 80 | 5 to 50 | 10 to 50 | 10 to 30 |
| Phosphate | <10 | <10 | <10 | <10 |
| Complexing agent | <2.5 | <2.5 | <2.5 | <2.5 |
| Misc | ad 100 | ad 100 | ad 100 | ad 100 |

TABLE 19

| | Formula- | Formula- | Formula- | Formula- |
|---|---|---|---|---|
| | tion 73 | tion 74 | tion 75 | tion 76 |
| | [wt. %] | [wt. %] | [wt. %] | [wt. %] |
| Ingredients in W. & C. | | | | |
| Preparation A | | | | |
| (Hydrogen) carbonate | 2 to 30 | 2 to 30 | 3 to 20 | 4 to 15 |
| Citrate | 2 to 40 | 5 to 30 | 5 to 30 | 7 to 20 |
| EDDS | 3 to 35 | 3 to 35 | 4 to 30 | 8 to 25 |
| Phosphonate | 1 to 8 | 1.2 to 6 | 1.2 to 6 | 1.5 to 4 |
| Misc | ad 100 | ad 100 | ad 100 | ad 100 |
| Ingredients in W. & C. | | | | |
| Preparation B | | | | |
| Protease preparation | 5 to 50 | 7 to 40 | 10 to 30 | 15 to 25 |
| Amylase preparation | 0.1 to 30 | 1 to 25 | 2 to 20 | 4 to 16 |
| Phosphate | <10 | <10 | <10 | <10 |
| Complexing agent | <2.5 | <2.5 | <2.5 | <2.5 |
| Misc | ad 100 | ad 100 | ad 100 | ad 100 |

TABLE 20

| | Formula- | Formula- | Formula- | Formula- |
|---|---|---|---|---|
| | tion 77 | tion 78 | tion 79 | tion 80 |
| | [wt. %] | [wt. %] | [wt. %] | [wt. %] |
| Ingredients in W. & C. | | | | |
| Preparation A | | | | |
| Builder | 2 to 50 | 2 to 50 | 2 to 50 | 2 to 50 |
| Complexing agent | 2 to 40 | 2 to 40 | 2 to 40 | 2 to 40 |
| Surfactants | 4 to 40 | 4 to 40 | 4 to 40 | 4 to 40 |
| Misc | ad 100 | ad 100 | ad 100 | ad 100 |
| Ingredients in W. & C. | | | | |
| Preparation B | | | | |
| Lipase preparation | 2 to 20 | 0 to 20 | 0 to 20 | 2 to 20 |
| Cellulase preparation | 0 to 20 | 2 to 20 | 0 to 20 | 2 to 20 |
| Mannanase | 0 to 20 | 0 to 20 | 2 to 20 | 2 to 20 |
| preparation | | | | |
| Phosphate | <10 | <10 | <10 | <10 |
| Complexing agent | <2.5 | <2.5 | <2.5 | <2.5 |
| Misc | ad 100 | ad 100 | ad 100 | ad 100 |

The washing or cleaning agent preparations B of the inventive washing or cleaning agent presentation forms comprise less than 10 wt. % phosphate and further less than 2.5 wt. % complexing agent. Reducing the phosphate and complexing agent contents to below these limits has proved to be advantageous for the washing and cleaning power. A further reduction in the content of phosphate and complexing agent to significantly below the upper limits surprisingly enables an additional increase of the washing and cleaning power of the inventive washing or cleaning agent presentation forms to be realized.

For this reason, inventively preferred washing or cleaning agent presentation forms are those wherein the washing or cleaning agent preparation B comprises less than 6 wt. % phosphate, preferably less than 3 wt. % phosphate, particularly preferably less than 1 wt. % phosphate and especially no phosphate.

Similarly, inventively preferred washing or cleaning agent presentation forms are those wherein the washing or cleaning agent preparation B comprises less than 2.0 wt. % complexing agent, preferably less than 1.0 wt. % complexing agent, particularly preferably less than 0.5 wt. % complexing agent and especially no complexing agent.

The total amount of the phosphate and complexing agent comprised in the washing or cleaning agent preparation B is preferably less than 10 wt. %, advantageously less than 6 wt. %, particularly preferably less than 2 wt. % and especially 0 wt. %.

The composition of some exemplary inventive washing or cleaning agent presentation forms that contain the washing and cleaning agent preparation A as well as the washing or cleaning agent preparation B can be found in the following TABLES 21-30:

Tables 21-30: Exemplary Packaged Washing or Cleaning Agents

TABLE 21

| | Formula- | Formula- | Formula- | Formula- |
|---|---|---|---|---|
| | tion 81 | tion 82 | tion 83 | tion 84 |
| | [wt. %] | [wt. %] | [wt. %] | [wt. %] |
| Ingredients in W. & C. | | | | |
| Preparation A | | | | |
| Builder | 2 to 50 | 2 to 50 | 6 to 45 | 10 to 40 |
| Complexing agent | 2 to 60 | 4 to 55 | 4 to 55 | 8 to 60 |
| Misc | ad 100 | ad 100 | ad 100 | ad 100 |
| Ingredients in W. & C. | | | | |
| Preparation B | | | | |
| Enzyme preparation | 5 to 80 | 5 to 50 | 10 to 50 | 10 to 30 |
| Phosphate | <6 | <3 | <1 | 0 |
| Complexing agent | <2 | <1 | <0.5 | 0 |
| Misc | ad 100 | ad 100 | ad 100 | ad 100 |

TABLE 22

| | Formula- | Formula- | Formula- | Formula- |
|---|---|---|---|---|
| | tion 85 | tion 86 | tion 87 | tion 88 |
| | [wt. %] | [wt. %] | [wt. %] | [wt. %] |
| Ingredients in W. & C. | | | | |
| Preparation A | | | | |
| (Hydrogen) carbonate | 2 to 30 | 2 to 30 | 3 to 20 | 4 to 15 |
| Citrate | 2 to 40 | 5 to 30 | 5 to 30 | 7 to 20 |
| Complexing agent | 2 to 60 | 4 to 55 | 4 to 55 | 8 to 60 |
| Misc | ad 100 | ad 100 | ad 100 | ad 100 |
| Ingredients in W. & C. | | | | |
| Preparation B | | | | |
| Enzyme preparation | 5 to 80 | 5 to 50 | 10 to 50 | 10 to 30 |
| Phosphate | <6 | <3 | <1 | 0 |
| Complexing agent | <2 | <1 | <0.5 | 0 |
| Misc | ad 100 | ad 100 | ad 100 | ad 100 |

TABLE 23

| | Formula- | Formula- | Formula- | Formula- |
|---|---|---|---|---|
| | tion 89 | tion 90 | tion 91 | tion 92 |
| | [wt. %] | [wt. %] | [wt. %] | [wt. %] |
| Ingredients in W. & C. | | | | |
| Preparation A | | | | |
| Builder | 2 to 50 | 2 to 50 | 6 to 45 | 10 to 40 |
| EDDS | 3 to 35 | 3 to 35 | 4 to 30 | 8 to 25 |
| Misc | ad 100 | ad 100 | ad 100 | ad 100 |
| Ingredients in W. & C. | | | | |
| Preparation B | | | | |
| Enzyme preparation | 5 to 80 | 5 to 50 | 10 to 50 | 10 to 30 |
| Phosphate | <6 | <3 | <1 | 0 |
| Complexing agent | <2 | <1 | <0.5 | 0 |
| Misc | ad 100 | ad 100 | ad 100 | ad 100 |

TABLE 24

| | Formula- | Formula- | Formula- | Formula- |
|---|---|---|---|---|
| | tion 93 | tion 94 | tion 95 | tion 96 |
| | [wt. %] | [wt. %] | [wt. %] | [wt. %] |
| Ingredients in W. & C. | | | | |
| Preparation A | | | | |
| (Hydrogen) carbonate | 2 to 30 | 2 to 30 | 3 to 20 | 4 to 15 |
| Citrate | 2 to 40 | 5 to 30 | 5 to 30 | 7 to 20 |
| EDDS | 3 to 35 | 3 to 35 | 4 to 30 | 8 to 25 |
| Misc | ad 100 | ad 100 | ad 100 | ad 100 |
| Ingredients in W. & C. | | | | |
| Preparation B | | | | |
| Enzyme preparation | 5 to 80 | 5 to 50 | 10 to 50 | 10 to 30 |
| Phosphate | <6 | <3 | <1 | 0 |
| Complexing agent | <2 | <1 | <0.5 | 0 |
| Misc | ad 100 | ad 100 | ad 100 | ad 100 |

TABLE 25

| | Formula- | Formula- | Formula- | Formula- |
|---|---|---|---|---|
| | tion 97 | tion 98 | tion 99 | tion 100 |
| | [wt. %] | [wt. %] | [wt. %] | [wt. %] |
| Ingredients in W. & C. | | | | |
| Preparation A | | | | |
| Builder | 2 to 50 | 2 to 50 | 6 to 45 | 10 to 40 |
| Phosphonate | 1 to 8 | 1.2 to 6 | 1.2 to 6 | 1.5 to 4 |
| Misc | ad 100 | ad 100 | ad 100 | ad 100 |
| Ingredients in W. & C. | | | | |
| Preparation B | | | | |
| Enzyme preparation | 5 to 80 | 5 to 50 | 10 to 50 | 10 to 30 |
| Phosphate | <6 | <3 | <1 | 0 |
| Complexing agent | <2 | <1 | <0.5 | 0 |
| Misc | ad 100 | ad 100 | ad 100 | ad 100 |

TABLE 26

| | Formula- | Formula- | Formula- | Formula- |
|---|---|---|---|---|
| | tion 101 | tion 102 | tion 103 | tion 104 |
| | [wt. %] | [wt. %] | [wt. %] | [wt. %] |
| Ingredients in W. & C. | | | | |
| Preparation A | | | | |
| (Hydrogen) carbonate | 2 to 30 | 2 to 30 | 3 to 20 | 4 to 15 |
| Citrate | 2 to 40 | 5 to 30 | 5 to 30 | 7 to 20 |
| Phosphonate | 1 to 8 | 1.2 to 6 | 1.2 to 6 | 1.5 to 4 |
| Misc | ad 100 | ad 100 | ad 100 | ad 100 |
| Ingredients in W. & C. | | | | |
| Preparation B | | | | |
| Enzyme preparation | 5 to 80 | 5 to 50 | 10 to 50 | 10 to 30 |
| Phosphate | <6 | <3 | <1 | 0 |
| Complexing agent | <2 | <1 | <0.5 | 0 |
| Misc | ad 100 | ad 100 | ad 100 | ad 100 |

TABLE 27

| | Formula- | Formula- | Formula- | Formula- |
|---|---|---|---|---|
| | tion 105 | tion 106 | tion 107 | tion 108 |
| | [wt. %] | [wt. %] | [wt. %] | [wt. %] |
| Ingredients in W. & C. | | | | |
| Preparation A | | | | |
| Builder | 2 to 50 | 2 to 50 | 6 to 45 | 10 to 40 |
| EDDS | 3 to 35 | 3 to 35 | 4 to 30 | 8 to 25 |
| Phosphonate | 1 to 8 | 1.2 to 6 | 1.2 to 6 | 1.5 to 4 |
| Misc | ad 100 | ad 100 | ad 100 | ad 100 |
| Ingredients in W. & C. | | | | |
| Preparation B | | | | |
| Enzyme preparation | 5 to 80 | 5 to 50 | 10 to 50 | 10 to 30 |
| Phosphate | <6 | <3 | <1 | 0 |
| Complexing agent | <2 | <1 | <0.5 | 0 |
| Misc | ad 100 | ad 100 | ad 100 | ad 100 |

TABLE 28

| | Formula- | Formula- | Formula- | Formula- |
|---|---|---|---|---|
| | tion 109 | tion 110 | tion 111 | tion 112 |
| | [wt. %] | [wt. %] | [wt. %] | [wt. %] |
| Ingredients in W. & C. | | | | |
| Preparation A | | | | |
| (Hydrogen) carbonate | 2 to 30 | 2 to 30 | 3 to 20 | 4 to 15 |
| Citrate | 2 to 40 | 5 to 30 | 5 to 30 | 7 to 20 |
| EDDS | 3 to 35 | 3 to 35 | 4 to 30 | 8 to 25 |
| Phosphonate | 1 to 8 | 1.2 to 6 | 1.2 to 6 | 1.5 to 4 |
| Misc | ad 100 | ad 100 | ad 100 | ad 100 |
| Ingredients in W. & C. | | | | |
| Preparation B | | | | |
| Enzyme preparation | 5 to 80 | 5 to 50 | 10 to 50 | 10 to 30 |
| Phosphate | <6 | <3 | <1 | 0 |
| Complexing agent | <2 | <1 | <0.5 | 0 |
| Misc | ad 100 | ad 100 | ad 100 | ad 100 |

TABLE 29

| | Formula- | Formula- | Formula- | Formula- |
|---|---|---|---|---|
| | tion 113 | tion 114 | tion 115 | tion 116 |
| | [wt. %] | [wt. %] | [wt. %] | [wt. %] |
| Ingredients in W. & C. | | | | |
| Preparation A | | | | |
| (Hydrogen) carbonate | 2 to 30 | 2 to 30 | 3 to 20 | 4 to 15 |
| Citrate | 2 to 40 | 5 to 30 | 5 to 30 | 7 to 20 |
| EDDS | 3 to 35 | 3 to 35 | 4 to 30 | 8 to 25 |
| Phosphonate | 1 to 8 | 1.2 to 6 | 1.2 to 6 | 1.5 to 4 |
| Misc | ad 100 | ad 100 | ad 100 | ad 100 |
| Ingredients in W. & C. | | | | |
| Preparation B | | | | |
| Protease preparation | 5 to 50 | 7 to 40 | 10 to 30 | 15 to 25 |
| Amylase preparation | 0.1 to 30 | 1 to 25 | 2 to 20 | 4 to 16 |
| Phosphate | <6 | <3 | <1 | 0 |
| Complexing agent | <2 | <1 | <0.5 | 0 |
| Misc | ad 100 | ad 100 | ad 100 | ad 100 |

TABLE 30

| | Formula- | Formula- | Formula- | Formula- |
|---|---|---|---|---|
| | tion 117 | tion 118 | tion 119 | tion 120 |
| | [wt. %] | [wt. %] | [wt. %] | [wt. %] |
| Ingredients in W. & C. | | | | |
| Preparation A | | | | |
| Citrate | 2 to 40 | 3 to 30 | 2 to 40 | 3 to 30 |
| Complexing agent | 1 to 30 | 1 to 20 | 1 to 30 | 2 to 20 |
| Surfactants | 4 to 40 | 4 to 40 | 4 to 40 | 4 to 40 |
| Misc | ad 100 | ad 100 | ad 100 | ad 100 |
| Ingredients in W. & C. | | | | |
| Preparation B | | | | |
| Protease preparation | 0 to 30 | 0.1 to 30 | 0 to 30 | 0.1 to 30 |
| Preparation | 2 to 20 | 2 to 20 | 2 to 20 | 2 to 20 |
| comprising Amylase. | | | | |
| Cellulase, Lipase | | | | |
| and/or Mannanase | | | | |
| Phosphate | <3 | <3 | <1 | <1 |
| Complexing agent | <1 | <1 | <0.5 | <0.5 |
| Misc | ad 100 | ad 100 | ad 100 | ad 100 |

Organic solvents are an optional ingredient of the inventive washing or cleaning agent preparations, especially the washing or cleaning agent preparation B. Preferred organic solvents come from the group of the mono- or polyhydric alcohols, alkanolamines or glycol ethers. Preferably, the solvents are selected from ethanol, n- or i-propanol, butanol, glycol, propane diol or butane diol, glycerin, monoethanolamine, diglycol, propyl diglycol or butyl diglycol, hexylene glycol, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl-, -ethyl- or -propyl ether, dipropylene glycol methyl-, or -ethyl ether, methoxy-, ethoxy- or butoxy triglycol, 1-butoxyethoxy-2-propanol, 3-methyl-3-methoxybutanol, propylene glycol t-butyl ether as well as mixtures of these solvents. The weight fraction of these organic solvents in the total weight of the inventive washing or cleaning preparations is preferably 5 to 80 wt. %, preferably 10 to 60 wt. % and especially 20 to 50 wt. %.

A particularly preferred, and in regard to the stabilization of the washing or cleaning preparation, a particularly effective organic solvent is 1,2-propylene glycol. The weight fraction of the 1,2-propylene glycol in the total weight of the washing or cleaning agent preparations B according to the invention can vary over wide limits, although those preparations have proved to be particularly stable which comprise 5 to 80 wt. %, preferably 10 to 60 wt. % and in particular 20 to 50 wt. %, relative to the total weight of the washing or cleaning agent preparation B. Corresponding preparations are consequently inventively preferred.

Preferred washing or cleaning agent presentation forms according to the invention are those, wherein the washing or cleaning agent preparation B comprises an organic solvent, preferably 1,2-propylene glycol, wherein the weight fraction of the 1,2-propylene glycol is preferably 5 to 80 wt. %, preferably 10 to 60 wt. % and in particular 20 to 50 wt. %, relative to the total weight of the washing or cleaning agent preparation.

The composition of some exemplary inventive washing or cleaning agent presentation forms that contain the washing and cleaning agent preparation A as well as the washing or cleaning agent preparation B can be found in the following TABLES 31-32:

Tables 31-32: Exemplar Peed Washing or Cleaning Agents

TABLE 31

| | Formula- | Formula- | Formula- | Formula- |
|---|---|---|---|---|
| | tion 121 | tion 122 | tion 123 | tion 124 |
| | [wt. %] | [wt. %] | [wt. %] | [wt. %] |
| Ingredients in W. & C. | | | | |
| Preparation A | | | | |
| Builder | 2 to 50 | 2 to 50 | 6 to 45 | 10 to 40 |
| Complexing agent | 2 to 60 | 4 to 55 | 4 to 55 | 8 to 60 |
| Misc | ad 100 | ad 100 | ad 100 | ad 100 |
| Ingredients in W. & C. | | | | |
| Preparation B | | | | |
| Enzyme preparation | 5 to 80 | 5 to 50 | 10 to 50 | 10 to 30 |
| Phosphate | <6 | <3 | <1 | 0 |
| Complexing agent | <2 | <1 | <0.5 | 0 |
| 1,2-Propylene glycol | 5 to 80 | 5 to 80 | 10 to 60 | 20 to 50 |
| Misc | ad 100 | ad 100 | ad 100 | ad 100 |

TABLE 32

| | Formula- | Formula- | Formula- | Formula- |
|---|---|---|---|---|
| | tion 125 | tion 126 | tion 127 | tion 128 |
| | [wt. %] | [wt. %] | [wt. %] | [wt. %] |
| Ingredients in W. & C. | | | | |
| Preparation A | | | | |
| (Hydrogen) carbonate | 2 to 30 | 2 to 30 | 3 to 20 | 4 to 15 |
| Citrate | 2 to 40 | 5 to 30 | 5 to 30 | 7 to 20 |
| EDDS | 3 to 35 | 3 to 35 | 4 to 30 | 8 to 25 |
| Phosphonate | 1 to 8 | 1.2 to 6 | 1.2 to 6 | 1.5 to 4 |
| Misc | ad 100 | ad 100 | ad 100 | ad 100 |
| Ingredients in W. & C. | | | | |
| Preparation B | | | | |
| Protease preparation | 5 to 50 | 7 to 40 | 10 to 30 | 15 to 25 |
| Amylase preparation | 0.1 to 30 | 1 to 25 | 2 to 20 | 4 to 16 |
| Phosphate | <6 | <3 | <1 | 0 |
| Complexing agent | <2 | <1 | <0.5 | 0 |
| 1,2-Propylene glycol | 5 to 80 | 5 to 80 | 10 to 60 | 20 to 50 |
| Misc | ad 100 | ad 100 | ad 100 | ad 100 |

Another optional ingredient of the washing or cleaning agent preparations B according to the invention is a boric acid or a boric acid derivative. Besides boric acid, especially boronic acids or their salts or esters are preferably used in this regard, above all derivatives with aromatic groups, for example ortho, meta or para substituted phenyl boronic acids, particularly 4-formylphenyl boronic acid (4-FPBA), or the salts or esters of the cited compounds. The weight fraction of the boric acid or the boric acid derivatives in the total weight of the inventive washing or cleaning preparations B is preferably between 0.001 to 10 wt. %, preferably 0.002 to 6 wt. % and especially 0.05 to 3 wt. %.

A particularly preferred and in regard to the stabilization of the washing or cleaning preparation a particularly effective boric acid derivative is 4-formylphenyl boronic acid. The weight fraction of the 4-formylphenyl boronic acid in the total weight of the washing or cleaning agent preparations according to the invention can vary over wide limits, although those preparations have proved to be particularly stable which comprise 0.001 to 10 wt. %, preferably 0.002 to 6 wt. % and in particular 0.05 to 3 wt. % relative to the total weight of the washing or cleaning agent preparation. Corresponding preparations are consequently inventively preferred.

A third optional ingredient of the washing or cleaning agent preparations according to the invention is a Ca or Mg ion source. The weight fraction of the Ca or Mg ion source in the total weight of the inventive washing or cleaning preparations B is preferably between 0.01 to 10 wt. %, preferably 0.2 to 8 wt. % and especially 0.5 to 5 wt. %.

Particularly preferred, and in regard to the stabilization of the washing or cleaning preparation B, particularly effective sources of Ca ions, have proven to be the organic calcium salts.

The weight fraction of the organic calcium source in the total weight of the washing or cleaning agent preparations according to the invention can vary over wide limits, although those preparations have proved to be particularly stable which comprise 0.01 to 10 wt. %, preferably 0.2 to 8 wt. % and in particular 0.5 to 5 wt. % relative to the total weight of the washing or cleaning agent preparation. Corresponding preparations are consequently inventively preferred.

In addition, polyols, especially sorbitol, can also be comprised in inventively preferred washing or cleaning agent preparations B for stabilizing the enzymes.

The liquid washing or cleaning agent preparations B preferably comprise, relative to their total weight, 0.1 to 35 wt. %, preferably 1.5 to 25 wt. % and in particular 2.0 to 30 wt. % of water.

In a preferred embodiment of the inventive automatic dishwashing process or fabric washing process, the cleaning agent preparations A and B are employed in combination with at least one additional cleaning agent preparation C, or the “third” preparation. When used in a dishwashing process, this cleaning agent preparation C preferably comprises surfactant and/or acid. When used in a fabric washing process, this cleaning agent preparation C preferably comprises a fabric conditioner and/or a perfume.

The achieved rinse power can be improved in the inventive dishwashing process by adding a cleaning agent preparation C that comprises surfactant and/or acid. This is especially true for those preferred process variants, in which the cleaning agent preparations A, B and C are dosed at different times. The non-ionic surfactants described above are particularly suitable surfactant additives for the cleaning agent preparation C. However, non-ionic surfactants of the general Formula R¹—CH(OH)CH₂O-(AO)_{w}-(A′O)ₓ-(A″O)_{y}-(A″O)_{z}—R² are advantageously employed, in which:
R¹ stands for a straight chain or branched, saturated or mono- or polyunsaturated C₆₋₂₄ alkyl or alkenyl group;
R² stands for a linear or branched hydrocarbon group containing 2 to 26 carbon atoms;
A, A′, A″ and A′″ independently of one another stand for a group from the group —CH₂CH₂, —CH₂CH₂—CH₂, —CH₂—CH(CH₃), —CH₂—CH₂—CH₂—CH₂, —CH₂—CH(CH₃)—CH₂—, —CH₂—CH(CH₂—CH₃); and
w, x, y and z stand for values between 0.5 and 120, wherein x, y and/or z can also be 0.

In this regard, the non-ionic surfactants of the general Formula R¹—CH(OH)CH₂O-(AO)_{w}—R² have proved to be particularly effective, in which:
R¹ stands for a straight chain or branched, saturated or mono- or polyunsaturated C₆₋₂₄ alkyl or alkenyl group;
R² stands for a linear or branched hydrocarbon group containing 2 to 26 carbon atoms;
A is selected from the group CH₂CH₂, —CH₂CH₂—CH₂, —CH₂—CH(CH₃); and w stands for values between 1 and 120, preferably 10 to 80, in particular 20 to 40.

The group of these non-ionic surfactants includes for example the C₄₋₂₂ fatty alcohol-(PO)₁₀₋₈₀-2-hydroxyalkyl ethers, in particular also the C₈₋₁₂ fatty alcohol-(EO)₂₂-2-hydroxydecyl ethers and the C₄₋₂₂ fatty alcohol-(EO)₄₀₋₈₀-2-hydroxyalkyl ethers.

The weight fraction of the non-ionic surfactant in the total weight of the cleaning agent preparation C is advantageously from 1.0 to 18 wt. %, preferably from 2.0 to 15, particularly from 4.0 to 12 wt. % and especially from 6.0 to 10 wt. %.

In addition to or alternatively to the non-ionic surfactants, the inventive cleaning agent preparations C preferably comprise at least one acidifier, when employed in a dishwashing process. Acidifiers can be added to the inventive cleaning agent preparations C in order to lower the pH of the wash liquor in the rinse cycle. Both inorganic acids and organic acids are available as acidifiers, as long as they are compatible with the usual ingredients. For reasons of consumer protection and handling safety, the solid mono, oligo and polycarboxylic acids are particularly suitable. Within this group, citric acid, tartaric acid, succinic acid, malonic acid, adipic acid, maleic acid, fumaric acid, oxalic acid and polyacrylic acid are again preferred. Organic sulfonic acids, such as amidosulfonic acid, may also be used. Sokalan® DCS (trademark of BASF), a mixture of succinic acid (max. 31% by weight), glutaric acid (max. 50% by weight) and adipic acid (max. 33% by weight), is commercially available and may also be used with advantage as an acidifier in the context of the present invention. Cleaning agent preparations C that comprise, based on the total weight of the cleaning agent preparation C, one or more acidifiers, preferably mono, oligo and polycarboxylic acids, particularly preferably tartaric acid, succinic acid, malonic acid, adipic acid, maleic acid, fumaric acid, oxalic acid and polyacrylic acids and in particular acetic acid and/or citric acid in amounts of 0.1 to 12 wt. %, preferably 0.2 to 10 wt. % and especially 0.4 to 8.0 wt. %, are preferred embodiments of the present invention.

When used in a fabric washing process, inventive cleaning preparations C preferably comprise at least one compound selected from fabric conditioners, defoamers, in particular polydimethylsiloxanes, complexing agents and perfumes. In this regard, the fabric conditioner is preferably selected from fabric softeners, especially esterquats and quaternary silicone compounds, optical brighteners and soil-release active products. Fabric softeners are particularly preferably employed in the cleaning preparation C. The fabric softener is preferably comprised in inventive cleaning preparations C in an amount of 2 to 30 wt. %, especially 4 to 20 wt. %.

In regard to inventively preferably useable fabric softeners, reference is made to the laid open document WO 2007/087953. The already previously described compounds are employed as the complexing agent. In regard to inventively preferably useable perfumes, optical brighteners and soil-release active products and their preferred added quantities, reference is made to the laid open document WO 2008/101810.

The previously described cleaning agent preparations A, B and C differ in regard to their composition and are therefore not identical.

The composition of some exemplary inventive washing or cleaning agent presentation forms that contain the washing and cleaning agent preparations A, B and C can be found in the following TABLES 33-34.

Tables 33-34: Exemplary Packaged Washing or Cleaning Agents

TABLE 33

| | Formula- | Formula- | Formula- | Formula- |
|---|---|---|---|---|
| | tion 129 | tion 130 | tion 131 | tion 132 |
| | [wt. %] | [wt. %] | [wt. %] | [wt. %] |
| Ingredients in W. & C. | | | | |
| Preparation A | | | | |
| Builder | 2 to 50 | 2 to 50 | 6 to 45 | 10 to 40 |
| Complexing agent | 2 to 60 | 4 to 55 | 4 to 55 | 8 to 60 |
| Misc | ad 100 | ad 100 | ad 100 | ad 100 |
| Ingredients in W. & C. | | | | |
| Preparation B | | | | |
| Enzyme preparation | at least 5 | at least 5 | at least 5 | at least 5 |
| Phosphate | <10 | <10 | <10 | <10 |
| Complexing agent | <2.5 | <2.5 | <2.5 | <2.5 |
| Misc | ad 100 | ad 100 | ad 100 | ad 100 |
| Ingredients in W. & C. | | | | |
| Preparation C | | | | |
| Nonionic surfactant | yes | yes | yes | yes |
| and/or acid | | | | |
| Misc | ad 100 | ad 100 | ad 100 | ad 100 |

TABLE 34

| | Formula- | Formula- | Formula- | Formula- |
|---|---|---|---|---|
| | tion 133 | tion 134 | tion 135 | tion 136 |
| | [wt. %] | [wt. %] | [wt. %] | [wt. %] |
| Ingredients in W. & C. | | | | |
| Preparation A | | | | |
| Builder | 2 to 50 | 2 to 50 | 2 to 30 | 4 to 30 |
| Complexing agent | 2 to 60 | 2 to 50 | 2 to 30 | 2 to 30 |
| Surfactants | 2 to 40 | 4 to 40 | 5 to 35 | 5 to 35 |
| Misc | ad 100 | ad 100 | ad 100 | ad 100 |
| Ingredients in W. & C. | | | | |
| Preparation B | | | | |
| Enzyme preparation | at least 5 | at least 5 | at least 5 | at least 5 |
| Phosphate | <10 | <10 | <10 | <10 |
| Complexing agent | <2.5 | <2.5 | <2.5 | <2.5 |
| Misc | ad 100 | ad 100 | ad 100 | ad 100 |
| Ingredients in W. & C. | | | | |
| Preparation C | | | | |
| Fabric conditioner | yes | yes | yes | yes |
| and/or perfume | | | | |
| Misc | ad 100 | ad 100 | ad 100 | ad 100 |

The previously described combination of cleaning agents is made up by means of a packaging means, in which the washing or cleaning preparations A and B or A, B and C are physically separate and distanced from each other. This separation can be achieved for example by means of separate receiving chambers, wherein each of these receiving chambers comprises one of the cleaning agents that are combined together. Examples of such made-up forms are cartridges with two, three, four or more separate receiving chambers, for example two, three, four or multi-chamber bottles. Unwanted reactions due to chemical incompatibility can be excluded by separating the cleaning agents of different composition.

A further subject matter of the present application is a cleaning agent presentation form, comprising:
a) an inventive washing or cleaning agent preparation A in a sufficient amount for carrying out at least two, preferably at least four and in particular at least eight automatic dishwasher processes or automatic fabric washing processes;
b) at least one additional washing or cleaning agent preparation B that differs from A in a sufficient amount for carrying out at least two, preferably at least four and in particular at least eight automatic dishwasher processes or automatic fabric washing processes;
c) optionally, an additional washing or cleaning agent preparation C that differs from A and B in a sufficient amount for carrying out at least two, preferably at least four and in particular at least eight automatic dishwasher processes or automatic fabric washing processes; and
d) a cartridge for the washing or cleaning agent preparations A and B or A, B and C, in which cartridge said washing or cleaning agent preparations A and B or A, B and C are in separate receiving chambers.

Another subject matter of the present application is a cleaning agent dosing system, comprising:
a) an inventive washing or cleaning agent preparation A in a sufficient amount for carrying out at least two, preferably at least four and in particular at least eight automatic dishwasher processes or automatic fabric washing processes;
b) at least one additional washing or cleaning agent preparation B that differs from A in a sufficient amount for carrying out at least two, preferably at least four and in particular at least eight automatic dishwasher processes or automatic fabric washing processes;
c) optionally, an additional washing or cleaning agent preparation C that differs from A and B in a sufficient amount for carrying out at least two, preferably at least four and in particular at least eight automatic dishwasher processes or automatic fabric washing processes;
d) a cartridge for the washing or cleaning agent preparations A and B or A, B and C, in which cartridge said washing or cleaning agent preparations A and B or A, B and C are in separate receiving chambers; and
e) a dosing device that is releasably connected to the cartridge.

In a preferred embodiment, the previously described cartridges of the cleaning agent presentation form are provided with a dosing device that can be detached from the cartridge. A dosing device of this type can be connected to the cartridge by means of, for example, an adhesive bond, a latch connection, a snap-in connection or push-fit connection. The cartridge is more easily filled up for example by separating the cartridge from the dosing device. Alternatively, the detachable connection of the cartridge from the dosing device enables the cartridges to be exchanged on the dosing device. Such an exchange can be displayed for example when the cleaning process is changed or when the cartridge has been completely emptied.

A particularly preferred subject matter of this application is a cleaning agent dosing system, comprising:
a) an inventive cleaning agent presentation form, comprising a sufficient amount of cleaning agent preparations A and B or A, B and C for carrying out at least two, preferably at least four and in particular at least eight automatic dishwasher processes or automatic fabric washing processes; and
b) a dosing device that is removably connected with the cleaning agent presentation form.

Cleaning agent presentation forms are of course also conceivable, in which the cartridge and the dosing device are un-releasably connected with one another.

Another subject matter of the present application is a cleaning agent dosing system, comprising:
a) an inventive cleaning agent presentation form, comprising a sufficient amount of cleaning agent preparations A and B or A, B and C for carrying out at least two, preferably at least four and in particular at least eight automatic dishwasher processes or automatic fabric washing processes; and
b) a dosing device that is un-removably connected with the cleaning agent presentation form.

In a preferred embodiment, the abovementioned cleaning agent dosing systems, comprising an inventive cleaning agent (as well as optionally one or two additional cleaning agents that differ from the inventive cleaning agent preparations A and B), a cartridge and a dosing device that is releasably connected with the cartridge, are presented in a common packaging unit, wherein the filled cartridge and the dosing device are particularly preferably comprised separately in the packaging unit. The packaging unit is used for the storage, transport and the presentation of the inventive cleaning agent presentation form and protects it from stains, shocks and knocks.

The packaging unit should be designed to be at least partially transparent, in particular for the purposes of presentation.

Alternatively or in addition to a packaging unit, the possibility naturally exists to commercialize the inventive cleaning agent presentation form together with an automatic dishwasher or together with a fabric washing machine A combination of this type is particularly advantageous in those cases, in which the cycle of the automatic dishwasher process or washing process (e.g. duration, temperature cycle, water supply) and the cleaning agent formulation or the control electronics of the dosing device are coordinated with each other.

The inventive dosing system consists of the basic components of a cartridge filled with the inventive cleaning agent, and a dosing device that is connectable with the cartridge, said dosing device being again formed from additional groups of components, such as for example component support, actuator, closing element, sensor, energy source and/or control unit.

The inventive dosing system is preferably movable. In the context of this application, “movable” means that the dosing system is not non-detachably connected with a water-conducting device such as for example an automatic dishwasher, washing machine, washer dryer or the like, but rather can be removed for example from an automatic dishwasher by the consumer or can be placed in an automatic dishwasher, i.e. it is independently manageable.

According to an alternative development of the invention, it is also conceivable that the dosing device for the consumer is not releasably connected with a water-conducting device, such as for example an automatic dishwasher, washing machine, washer dryer or the like and only the cartridge can be moved.

As the pH of the preparations to be dosed can be between 2 and 14, in particular 2 and 12, depending on the intended use, all components of the dosing system which come into contact with the preparations should be appropriately resistant to acid and alkali. Moreover, by choosing suitable materials, these components should be as far as possible chemically inert, for example towards non-ionic surfactants, enzymes and/or fragrances.

### Cartridge

In the context of this application, the term “cartridge” is understood to mean a package that is suitable for encasing or holding together free-flowing or dispersible preparations, and that can be coupled with a dosing device to dispense the preparation.

In particular, a cartridge can also contain a plurality of chambers that can be filled up independently of each other with different preparations. It is also conceivable for a plurality of containers to be assembled into one cartridge unit.

The cartridge advantageously possesses at least one outlet that is arranged such that in the operating state of the dosing device the product can be released by gravity from the container. This ensures that additional means of conveyance for releasing the product out of the container are not needed, with the result that the dosing device is of a simple design and the production costs can be kept low.

In a preferred development of the invention, at least a second chamber for receiving at least one second free-flowing or dispersible product is provided, wherein the second chamber possesses at least one outlet that is arranged such that in the operating state of the dosing device the product can be released by gravity from the second chamber. The design of a second container is then particularly advantageous when preparations that are stored in the independent containers are not usually storage-stable together, such as for example bleaching agents and enzymes.

Moreover, it is conceivable that more than two, in particular three to four chambers are provided in or on one cartridge. In particular, one of the chambers can be designed for dispensing volatile preparations, such as for example a fragrance, into the surroundings.

In a further development of the invention, the cartridges are integrally formed. In this way the cartridges can be made in a cost-effective manner in one production step, especially by an appropriate blow molding process. In this regard, the chambers of a cartridge can be separated from one another by partition walls or bridges of material.

The cartridges can also be manufactured in a multi-piece design by injection molding and subsequently formed from the assembled components.

Furthermore, it is conceivable for the cartridge to be formed in a multi-piece design such that at least one chamber, preferably all chambers, can be individually removed from, or inserted into, the dosing device. In this way it is possible, in the case of a differently high level of consumption of a preparation from one chamber, to exchange an already emptied chamber, whereas the others that still contain preparations in them remain in the dosing device. Thus a selected and as-needed refill of the individual chambers or their preparations can be carried out.

The chambers of a cartridge can be fastened to one another by suitable connection methods, thereby forming a container unit. The chambers can be fixed detachably or non-detachably to each other by means of an interlocking, friction locked and/or material joined connection.

In particular, the connection can be made by one or more of the connecting types from the group of the snap-in connections, Velcro® fasteners, press-fitted assemblies, fused joints, adhesive joints, welded joints, soldered joints, screw connections, key joints, clamp joints or press stud connections. In particular, the connection can also be formed by means of a shrink sleeve that in a heated state is pulled, at least partially, over the cartridge and when cooled strongly envelops the chambers or the cartridge.

In order to provide advantageous emptying characteristics of the residues of the chamber, the floor of the chamber can be in the shape of a funnel inclined towards the outlet. Further, by the choice of suitable materials and/or surface characteristics, the interior wall of a chamber can be made in such a way that the product exhibits low material adhesion to the interior chamber wall. This technique also further optimizes the emptying of the remaining product from the chamber.

The chambers can have the same or different fill volumes. In a two-container configuration the ratio of the container volumes is preferably 5:1, in a three-container configuration preferably 4:1:1, these configurations being particularly suitable for use in automatic dishwashers.

As mentioned above, the cartridge preferably has 3 chambers. When employing this type of cartridge in an automatic dishwasher, it is particularly preferred that the first chamber contains an alkaline cleaning preparation, the second chamber contains an enzymatic preparation and the third chamber contains a rinse aid, wherein the volumetric ratio of the chambers is for example 4:1:1.

A dosing chamber can be designed in or on one chamber in the flow direction of the preparation before the outlet. The dosing chamber defines the amount of the preparation that is intended to be released from the chamber into the surroundings. This is then particularly advantageous when the closure element of the dosing device which affects the discharge of the preparation from a chamber into the surroundings, can be shifted only into a discharge and a closed position without controlling the discharge quantity. The dosing chamber then provides for a predefined quantity of preparation to be released, without a direct feedback of the defined quantity of dispensed preparation. The dosing chambers can be formed integrally or in multi parts.

According to another advantageous further development of the invention, one or more chambers each have, in addition to an outlet port, a liquid-tight closable chamber opening. This chamber opening allows for example the preparation that is kept in this chamber to be filled up.

Ventilation means can be provided, especially in the top portion of the cartridge, for ventilating the cartridge chambers in order to ensure a pressure equalization between the interior of the cartridge chambers and the surroundings as the filling level decreases in the chambers. These ventilation means can be designed for example as a valve, especially silicone valves, micro-openings in the cartridge wall or the like.

If, in accordance with another development, it is not intended to directly ventilate the cartridge chambers, but rather to provide ventilation through the dosing device or no ventilation at all, e.g. by using flexible containers, such as for example pouches, then this has the advantage that a pressure will be created at increased temperatures during a cleaning cycle of an automatic dishwasher as the contents of the chamber warm up, and said pressure pushes the preparations to be dosed in the direction of the outlet openings, such that the cartridge can be easily emptied of any residual preparation in this way. Furthermore, with an air-free packaging of this type there exists no danger of any oxidation of the substances in the preparation, thereby making a pouch packaging or even a bag-in-bottle packaging advantageously appropriate, especially for oxidation-sensitive preparations.

The cartridge usually has a filling volume (capacity) of <5000 ml, in particular <1000 ml, preferably <500 ml, particularly preferably <250 ml, quite particularly preferably <50 ml.

The cartridge can assume any shape. For example it can be in the shape of a cube, a sphere or a disc.

The shape of the cartridge and the dosing device can be designed in such a way that they take up as little useful volume as possible, especially in an automatic dishwasher.

For the use of the dosing device in automatic dishwashers, it is particularly advantageous to shape the dosing device as a function of the dishes to be cleaned in the automatic dishwasher. Thus, the dosing device can be designed for example in the shape of a disc, with approximately the dimensions of a plate.

In this way the dosing device can be positioned in a space-saving way, such as by placement in the lower tray of the dishwasher. Moreover, due to the plate-like shape, the consumer can intuitively position the dosing unit correctly. The dimensions of the cartridge are preferably in the ratio height:width:depth between 5:5:1 and 50:50:1, particularly preferably about 10:10:1. In particular, the “slim” design of the dosing device and the cartridge allows the device to be positioned in the lower cutlery basket of an automatic dishwasher in the holding fixtures provided for the plates. This has the advantage that the preparations dispensed from the dosing device arrive directly into the wash liquor and cannot adhere to other articles being washed.

Typical commercial, domestic automatic dishwashers are designed such that larger items to be washed, for example pans or large plates, are placed in the lower tray of the dishwasher. In order to avoid that the consumer places the dosing system in a less than optimum position in the upper tray, then in an advantageous development of the invention, the dosing system is sized in such a way that it can be placed only in the holding fixtures provided for it in the lower tray. With this in mind, the width and the height of the dosing system can be chosen to be in particular between 150 mm and 300 mm, particularly preferably between 175 mm and 250 mm.

However, it is also conceivable to design the dosing unit in the form of a bowl with an essentially circular or rectangular base.

In order to protect heat-sensitive ingredients of a preparation in a cartridge against heat, the cartridge is advantageously manufactured from a material with a low thermal conductivity.

Another possibility for diminishing the action of heat on a preparation in a chamber of the cartridge is to insulate the chamber by suitable means, e.g. by using heat insulating materials such as for example Styropor® expandable polystyrene, which suitably enclose the chamber or the cartridge either completely or partially.

In a preferred embodiment of the invention, the cartridge has an RFID-tag that at least has information about the contents of the cartridge and which can be read by the sensor unit.

This information can be used to select a dosing program stored in the control unit. This ensures that a dosing program optimized for a particular preparation is always used. In the absence of an RFID-label or with an RFID-label with false or incorrect recognition, it can be arranged that the dosing device does not dose but instead emits an optical or acoustic signal to inform the consumer of the fault.

In order to exclude any misuse of the cartridge, the cartridges can also possess structural elements that cooperate according to the lock and key principle with the corresponding elements of the dosing device, such that for example only cartridges of a particular type can be coupled with the dosing device. Moreover, this design ensures that information concerning the cartridges coupled with the dosing device is communicated to the control unit, thereby enabling a coordinated control of the dosing device according to the contents of the corresponding container.

The cartridge is designed especially for receiving free-flowing washing or cleaning agents. This type of cartridge particularly preferably possesses a plurality of chambers for the spatially separate reception of each of the different preparations of a washing or cleaning agent,

The cartridge can be designed such that it can be releasably or fixedly arranged in or to the automatic dishwasher.

### Dosing Device

The control unit, sensor unit as well as at least one actuator required for operation are integrated in the dosing device. An energy source is likewise preferably positioned in the dosing device.

The dosing device preferably consists of a housing that is impervious to water splashes and which prevents the ingress of water splashes into the interior of the dosing device, as can occur, for example, when the dosing device according to the invention is used in an automatic dishwasher.

It is particularly preferred that the dosing device comprises at least one first interface that interacts with a corresponding constructed interface located in or on a water-supplying device, such as in particular a water-supplying domestic appliance, preferably an automatic dishwasher or washing machine, such that a transfer of electrical energy from the water-supplying appliance to the dosing unit is realized.

In one development of the invention, the interfaces are formed by plug-in connectors. In another development, the interfaces can be designed such that a wireless transfer of electric energy is affected.

In an advantageous further development of the invention, a second interface is arranged on each dosing device and the water-supplying appliance, such as for example an automatic dishwasher, for transferring electromagnetic signals that in particular represents information on the operating state, measurement and/or control of the dosing device and/or of the water-supplying appliance such as an automatic dishwasher.

### Adapter

A simple coupling of the dosing system to a water-supplying domestic appliance can be realized by means of an adapter. The adapter serves to link the mechanical and/or electrical connection of the dosing system with the water-supplying domestic appliance.

The adapter is preferably fixedly connected with a water-supplying pipe of the domestic appliance. However, it is also conceivable to provide the adapter to be placed in or on the household appliance, in which the adapter is protected from the flow of water and/or spray jet of the domestic appliance.

The adapter enables a dosing system to be designed both for a self-contained as well as a “built-in” version. It is also possible to design the adapter as a type of charging station for the dosing system in which for example the energy source of the dosing device is recharged or data are exchanged between the dosing device and the adapter.

The adapter can be placed in an automatic dishwasher on one of the interior walls of the washing chamber, in particular on the interior side of the door of the automatic dishwasher. However, it is also conceivable to place the adapter in the water-supplying household appliance where as such it is not accessible to the consumer, such that the dosing device is inserted into the adapter for example during the assembly of the household appliance, wherein the adapter, the dosing device and the household appliance are designed such that a cartridge from the consumer can be coupled with the dosing device.

The inventive cleaning agent presentation forms are suitable for use in dish washing as well as for fabric cleaning; nonetheless the use of an inventive cleaning agent presentation form or a cleaning agent dosing system for washing dishes in an automatic dishwasher process is preferred.

As stated in the introduction, the inventive cleaning agents are characterized by a particular physical and chemical stability, in particular towards temperature fluctuations. Accordingly, the inventive cleaning agents are exceptionally suitable for dosing by means of a dosing system that is located in the interior of a washing machine or automatic dishwasher. Such a dosing system that can be fixedly integrated in the interior of the washing machine or automatic dishwasher (machine-integrated dosing device) but can of course also be inserted as a movable device into the interior (self-contained dosing device), comprises a multiple of the amount of the cleaning agent required for carrying out an automatic cleaning process.

In the context of this application, “movable” means that the dispensing and dosing system is not non-detachably connected with a device, such as for example an automatic dishwasher, washing machine, washer dryer or the like, but rather can be removed for example from an automatic dishwasher or can be placed in an automatic dishwasher.

The use of an inventive cleaning agent presentation form for filling:
i) a cartridge of a dosing system fixedly integrated in the interior of an automatic dishwasher or fabric washing machine; or
ii) a movable cartridge of a dosing system designed to be placed in the interior space of an automatic dishwasher or fabric washing machine,
   with a sufficient amount of said cleaning agent presentation form for carrying out at least two, preferably at least four and in particular at least eight automatic dishwasher processes or automatic fabric washing processes, are likewise subject matters of this application.

An example of an immovable cartridge is a container that is immovably integrated into the interior, for example into the side wall or into the interior casing of the door of an automatic dishwasher.

An example of a movable cartridge is a container that is inserted into the interior of the automatic dishwasher by the consumer and that remains there during the complete cycle of a cleaning step. Such a cartridge can for example be integrated into the interior by simply placing it into the cutlery tray or dish tray but can also be removed again from the interior of the automatic dishwasher by the consumer.

The cleaning agent or the cleaning agent combination is dosed from the cartridge into the interior of the automatic dishwasher or fabric washing machine as described above, preferably by means of a dosing device that can be detached from the cartridge. A dosing device of this type can be connected to the cartridge by means of an adhesive bond, a latch connection, a snap-in connection or push-fit connection. Of course, cartridges with an undetachably connected dosing device can also be employed.

The use of an inventive cleaning agent presentation form as a cleaning agent reservoir for:
i) a dosing device that is fixedly integrated into the interior of an automatic dishwasher or fabric washing machine; or
ii) a moveable dosing device designed to be placed in the interior of an automatic dishwasher or fabric washing machine.

The use of an inventive cleaning agent dosing system as the cleaning agent reservoir for an automatic dishwasher or fabric washing machine is another subject matter of the present application.

Two further subject matters of this application are the use of an inventive cleaning agent presentation form, comprising:
a) an inventive washing or cleaning agent preparation A in a sufficient amount for carrying out at least two, preferably at least four and in particular at least eight automatic dishwasher processes or automatic fabric washing processes;
b) at least one additional washing or cleaning agent preparation B that differs from A in a sufficient amount for carrying out at least two, preferably at least four and in particular at least eight automatic dishwasher processes or automatic fabric washing processes;
c) optionally at least one additional washing or cleaning agent preparation C that differs from A and B in a sufficient amount for carrying out at least two, preferably at least four and in particular at least eight automatic dishwasher processes or automatic fabric washing processes; and
d) a cartridge for the washing or cleaning agent preparations A and B or A, B and C, in which cartridge said washing or cleaning agent preparations A and B or A, B and C are in separate receiving chambers as the cleaning agent reservoir for:
   i) a dosing device that is fixedly integrated into the interior of an automatic dishwasher or fabric washing machine or;
   ii) a moveable dosing device designed to be placed in the interior of an automatic dishwasher or fabric washing machine.

The inventive cleaning agents and cleaning agent combinations, as already stated, are preferably employed as an automatic dishwashing agent or as an automatic fabric washing agent.

Automatic dishwashing processes and automatic fabric washing processes using an inventive cleaning agent presentation form or an inventive cleaning agent dosing system are those wherein in their process cycle:
a partial quantity “a” of the inventive washing or cleaning agent preparation A that is present in the cartridge is dosed into the interior of the automatic dishwasher or fabric washing machine, wherein a residual amount of the washing or cleaning agent preparation that is present in the cartridge remains in the cartridge up to the end of the dishwashing process, wherein said residual amount corresponds to at least the double, preferably at least four times and in particular at least eight times the amount of the partial amount “a”; and
a partial quantity “b” of the inventive washing or cleaning agent preparation B that is present in the cartridge is dosed into the interior of the automatic dishwasher or fabric washing machine, wherein a residual amount of the washing or cleaning agent preparation that is present in the cartridge remains in the cartridge up to the end of the dishwashing process, wherein said residual amount corresponds to at least the double, preferably at least four times and in particular at least eight times the amount of the partial amount “b”; and optionally,
a partial quantity “c” of the inventive washing or cleaning agent preparation C that is present in the cartridge is dosed into the interior of the automatic dishwasher or fabric washing machine, wherein a residual amount of the washing or cleaning agent preparation that is present in the cartridge remains in the cartridge up to the end of the dishwashing process, wherein said residual amount corresponds to at least the double, preferably at least four times and in particular at least eight times the amount of the partial amount “c”,
   from a cartridge that is in the interior of the automatic dishwasher or fabric washing machine.

Of course, not only the inventive cleaning agent presentation forms but also the inventive cleaning agent dosing systems can be employed in the inventive dishwashing processes and fabric washing processes.

In a preferred embodiment, the dosing of the washing or cleaning agent A and the washing or cleaning agent B as well as the optional washing or cleaning agent C occurs at different times in the cleaning cycle.

Accordingly, another preferred subject matter of this application is an automatic dishwasher process or automatic fabric washing process using an inventive cleaning agent or an inventive cleaning agent presentation form or an inventive cleaning agent dosing system, in the course of which:

a) at a time t1 a partial quantity “a” of the inventive washing or cleaning agent preparation A is dosed into the interior of the automatic dishwasher or fabric washing machine from the cartridge that is present in the interior of the automatic dishwasher or fabric washing machine, wherein a residual amount of the cleaning agent present in the cartridge remains in the cartridge up to the end of the dishwashing process or fabric washing process and corresponds to at least the double, preferably at least four times and in particular at least eight times the amount of the partial amount “a”;
b) at least at another time t2≠t1 a partial quantity “b” of the inventive washing or cleaning agent preparation B that is different from the inventive washing or cleaning agent preparation A is dosed into the interior of the automatic dishwasher or fabric washing machine from the second cartridge that is present in the interior of the automatic dishwasher or fabric washing machine, wherein a residual amount of the washing or cleaning agent present in this cartridge remains in the cartridge up to the end of the dishwashing process or fabric washing process and corresponds to at least the double, preferably at least four times and in particular at least eight times the amount of the partial amount “b”; and
c) optionally at least at another time t3≠t2≠t1 a partial quantity “c” of the inventive washing or cleaning agent preparation C that is different from the inventive washing or cleaning agent preparations A and B is dosed into the interior of the automatic dishwasher or fabric washing machine from another cartridge that is present in the interior of the automatic dishwasher or fabric washing machine, wherein a residual amount of the cleaning agent C present in this cartridge remains in the cartridge up to the end of the dishwashing process or fabric washing process and corresponds to at least the double, preferably at least four times and in particular at least eight times the amount of the partial amount “c”.

In preferred embodiments of the above described automatic dishwasher processes with time-delayed dosing of the washing or cleaning agent preparations A and B or A, B and C, the time t2 is at least 1 minute, preferably at least 2 minutes and especially between 3 and 20 minutes before or after, preferably before the time t1. In preferred embodiments of the above described automatic dishwasher processes with time-delayed dosing of the washing or cleaning agent preparations A and B or A, B and C, the time t3 is additionally at least 1 minute, preferably at least 2 minutes and in particular between 3 and 30 minutes, especially between 3 and 20 minutes, before or after, preferably after the time t1.

In a preferred embodiment, in particular for a fabric washing process, the cleaning preparation B is dosed at a temperature of 20-35° C., then the cleaning preparation A is dosed at a temperature of 30-60° C. and afterwards the cleaning preparation C is dosed at a temperature below 20° C. into the interior preferably of a fabric washing machine.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

We claim:

1. A packaged washing or cleaning agent comprising:
a) a first liquid washing or cleaning agent preparation A comprising:
i. builder;
ii. complexing agent;
b) a second liquid washing or cleaning agent preparation B comprising:
i. greater than 1 wt. % water;
ii. at least 5 wt. % of at least one active washing or cleaning enzyme preparation;
iii. less than 10 wt. % phosphate; and
iv. less than 2.5 wt. % complexing agent; and
c) a packaging means containing and physically separating said first washing or cleaning preparation A and second washing or cleaning agent preparation B; wherein said first and second liquid washing or cleaning agent preparations have different compositions.

2. The packaged washing or cleaning agent of claim 1, wherein said builder is present from 2 to 50 wt. % based on the total weight of the first washing or cleaning agent preparation A.

3. The packaged washing or cleaning agent of claim 2, wherein said builder is present from 10 to 40 wt. % based on the total weight of the first washing or cleaning agent preparation A.

4. The packaged washing or cleaning agent of claim 1, wherein said builder is selected from the group consisting of carbonates, hydrogen carbonates, citrates, phosphates, silicates, polymeric carboxylates, polymeric sulfonates, and mixtures thereof.

5. The packaged washing or cleaning agent of claim 1, wherein said complexing agent present in said first washing or cleaning agent preparation A is present from 2 to 60 wt. % based on the total weight of the first washing or cleaning agent preparation A.

6. The packaged washing or cleaning agent of claim 5, wherein said complexing agent is present from 8 to 50 wt. % based on the total weight of the first washing or cleaning agent preparation A.

7. The packaged washing or cleaning agent of claim 1, wherein said complexing agent is selected from the group consisting of nitrilotriacetic acid, hydroxyethylethylenediamine triacetic acid, ethylenediamine tetraacetic acid, diethylenetriamine pentaacetic acid, methyl glycine diacetic acid, glutamic acid diacetic acid, imino disuccinic acid, hydroxyimino disuccinic acid, ethylenediamine disuccinic acid, aspartic acid diacetic acid, hydroxyethane-1,1-diphosphonic acid, diethylenetriamine penta(methylene phosphonic acid), and any of their salts thereof, and mixtures thereof.

8. The packaged washing or cleaning agent of claim 1, wherein said active washing or cleaning enzyme preparation is selected from the group consisting of amylases, proteases, cellulases, hemicellulases, lipases, and mixtures thereof.

9. The packaged washing or cleaning agent of claim 1, wherein said second washing or cleaning agent preparation B further comprises an organic solvent.

10. The packaged washing or cleaning agent of claim 9, wherein said organic solvent is 1,2-propylene glycol.

11. The packaged washing or cleaning agent of claim 10, wherein said 1,2-propylene glycol is present from 5 to 80 wt. %, based on the total weight of the second washing or cleaning agent preparation B.

12. The packaged washing or cleaning agent of claim 11, wherein said 1,2-propylene glycol is present from 20 to 50 wt. %, based on the total weight of the second washing or cleaning agent preparation B.

13. The packaged washing or cleaning agent of claim 1, wherein said water is present from 0.5 to 35 wt. %, based on the total weight of the second washing or cleaning agent preparation B.

14. The packaged washing or cleaning agent of claim 13, wherein said water is present from 2.0 to 30 wt. %, based on the total weight of the second washing or cleaning agent preparation B.

15. The packaged washing or cleaning agent of claim 1, wherein said first washing or cleaning agent preparation A further comprises from 5 to 35 wt. % of at least one surfactant, based on the total weight of said first washing or cleaning agent preparation A.

16. The packaged washing or cleaning agent of claim 15, wherein said at least one surfactant is present from 10 to 30 wt. %, based on the total weight of said first washing or cleaning agent preparation A.

17. The packaged washing or cleaning agent of claim 1 further comprising a third washing or cleaning agent preparation C, said third washing or cleaning agent preparation C comprising perfume substances and/or fabric conditioners and/or dishwasher rinse aids.

18. Use of the packaged washing or cleaning agent of claim 1 as a cleaning agent reservoir for:
a) a dosing device that is fixedly integrated into the interior of an automatic dishwasher or fabric washing machine; or
b) a moveable dosing device designed to be placed in the interior of an automatic dishwasher or fabric washing machine.

19. Use of the packaged washing or cleaning agent of claim 1 for filling:
a) a cartridge of a dosing system fixedly integrated in the interior of an automatic dishwasher or fabric washing machine; or
b) a movable cartridge of a dosing system designed to be placed in the interior of an automatic dishwasher or fabric washing machine;
with a sufficient amounts of said first and second washing or cleaning agent preparations for carrying out at least two automatic dishwasher processes or automatic fabric washing processes.

20. A cleaning agent dosing system, comprising:
a) packaged washing or cleaning agent of claim 1; and
b) a dosing device removably connected with said packaged washing or cleaning agent.
